(19) United States
(12) Patent Application Publication
(10) Pub. No.: US 2002/0067358 A1
(43) Pub. Date: Jun. 6, 2002

(54) Data analysis software

(76) Inventors: Georg Casari, Eppelheim (DE); Robin Munro, Heidelberg (DE); Pierre Monestie, Boston, MA (US); Christian Sonntag, Boston, MA (US)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/765,429

(22) Filed: Jan. 22, 2001

Related U.S. Application Data
(60) Provisional application No. 60/177,223, filed on Jan. 21, 2000.

(51) Int. Cl. G06T 11/20

(52) U.S. Cl. 345/440

(57) ABSTRACT

A method that enables defining relationships between data points (e.g. genes). The method disclosed is not limited by the size of the data set, the potentially misleading effect of background noise is reduced, relationship are not distorted, and that allows for comprehensible graphical presentation. The disclosed method solves the problem of visualization, analysis and interpretation of complex, multi-dimensional data. Such data may consist of data points from expression profiling analysis, 2D gel electrophoresis or SNP analysis. Here, multiple data sets exist and only the integration of all the sets into a two dimensional representation permits an analysis that allows the extraction of the information with respect to what events best explain the status of the cell, for example.

This application claims the benefit of U.S. Provisional Application No. 60/177,223, filed on Jan. 21, 2000.

### BACKGROUND OF THE INVENTION

1. Field of the Invention

This invention relates generally to devices, software, computer systems, and methods used to analyze gene expression data and more particularly to devices, software, computer systems, and methods used to analyze the large volume gene expression data generated in gene expression profiling experiments.

2. Description of the Related Art

Data analysis of large and/or complex sets of biological data is usually performed in two steps.

1) Statistical analysis of the raw data, treating the experimental errors, taking into account experimental constraints, and trying to filter and/or extract the relevant data points.

2) Attempting the interpretation of the identified subsets of data with respect to the general biological knowledge.

Methods available so far give partial solutions to either of these two steps but fail to support the complete process.

### Two Character States

Data stemming from expression profiling experiments has been very hard to analyze. To date, the analysis has mainly been done in such a way that two states are compared, a state A and a state E. Thus, only two data sets are compared as illustrated in Table I.

TABLE I
Two data sets

| | | |
|---|---|---|
| Status name: | A | E |
| Phenotype: | [symbol] | [symbol] |
| Influence: | Drug | No Drug |

The visualization of this data is done as graphs, an example of which is shown in FIG. 1. This graph plots expression levels of each state on a different axis, where differentially expressed genes are identified as being off-diagonal in that representation (e.g. Gene X in FIG. 1):

In real life however multiple data sets should be analyzed stemming from e.g. different time points or a series of experiments. Furthermore, the representation shown in FIG. 1 gives no indication on whether deviations from the diagonal are systematic and thus reflecting the studied biological phenomena or if they are due to experimental problems and thus lack of reproducibility.

In some special cases, comparison of only two experiments is sufficient. However, analysis of multiple data sets is far more desirable, as it reflects the general experimental situation. In theory such an analysis can be performed in pair wise comparisons of each pair of data sets. However, in practice this is far from efficient, as the sought for information is distributed over many representations. Furthermore, the number of such representations is proportional to the square of experiments and quickly outgrows the size that can be handled.

TABLE II
Mutiple data sets

| | | | | |
|---|---|---|---|---|
| Status name: | Drug | Drug | no Drug | no Drug |
| Phenotype: | [symbol] | [symbol] | [symbol] | [symbol] |
| Influence | Responder | responder | non responder | non responder |

The only approach, so far, that has shown to be successful in displaying the results of more than two experiments uses tree construction based on similarity in expression regulation and tree drawing algorithms as they are commonly used in sequence comparison of gene families (Eisen et al P. Brown Science 1998). This method is based on exhaustive pair wise comparisons of individual data points and can be so time consuming, that the use is limited and application to very large data sets becomes impossible.

The advantage of being able to display many similarity relationships is limited as the presentation of high numbers of similarity relationships in tree representations exceed the capacity of human comprehension. In addition, visualization of such extensive tree structures faces technical difficulties due to the requirements of very high resolution devices.

A fundamental problem of displaying many similarity relationships in a tree format is the limitations of the underlying tree algorithm forcing the data into an artificial tree structure. In reality, however, the depicted tree structure can not represent the true relationships and can create artificial similarities or spurious branching patterns. Such misleading artifacts may result in wrong conclusions including, for example, the problem of missing the influence and regulation of important genes in the analysis, even though the required measurements are available.

Therefore, it would be advantageous to provide for a method that can extract inherent structure from complex and/or large biological data sets, for example from large scale gene expression analysis or protein 2D-Gels.

### BRIEF SUMMARY OF THE INVENTION

The purpose of the invention is to provide for a method that enables defining relationships between data points (e.g. genes) whereby this method is not limited by the size of the data set, the potentially misleading effect of background noise is reduced, relationship are not distorted, and that allows for comprehensible graphical presentation.

The disclosed method solves the problem of visualization, analysis and interpretation of complex, multi-dimensional data. Such data may consist of data points from expression profiling analysis, 2D gel electrophoresis or SNP analysis. Here, multiple data sets exist and only the integration of all the sets into a two dimensional representation permits an analysis that allows the extraction of the information with respect to what events best explain the status of the cell, for example.

FIGS. 2 and 3 illustrate the problem. In state ‘A’ a given cell needs no air whereas in state E the cell has a pump running supplying the air. The essential switches are between B, C and D here a number of genes check the air status and finally start up the pump. A comparison between two given states e.g. A and E would therefore not have adequately described this change.

### BRIEF DESCRIPTION OF THE SEVERAL VIEWS OF THE DRAWINGS

FIG. 1 illustrates a prior art data plot.

FIGS. 2 and 3 show exemplary diagrams that illustrate the problems of the prior art.

FIG. 4 illustrates an exemplary login screen.

FIGS. 5 and 67 show samples of the graphic user interface (GUI).

FIGS. 6 and 61 illustrate an exemplary GUI where the user is in the process of creating a new project.

FIG. 7 provides a sample dialog box that is used to enter a name for a new project.

FIGS. 8 and 62 provide sample dialog boxes that are used to enter a name for a new experiment group.

FIGS. 9 and 63 provide sample dialog boxes that are used to add experiments to an experiment group.

FIG. 10 illustrates an exemplary variance histogram.

FIG. 11 shows a sample distance plot using default settings.

FIG. 12 provides an exemplary profile patterns dialog box.

FIG. 13 illustrates a sample distance plot using user selected settings.

FIG. 14 shows a sample gene list window.

FIG. 15 illustrates an exemplary SRS interface window.

FIG. 16 shows a sample of an SRS query.

FIG. 17 illustrates an exemplary gene expression profile.

FIG. 18 provides a sample of a scale tab.

FIG. 19 illustrates a sample of a red/green plot for fibroblast data.

FIG. 20 shows an example of a project folder display.

FIG. 21 illustrates an exemplary experiment group.

FIG. 22 provides an example of a dialog box that may be used to enter the name of a new experiment group.

FIG. 23 shows a sample of a dialog box used to select an experiment class.

FIG. 24 illustrates a sample of a dialog box that may be used to add experiments to an experiment group.

FIG. 25 provides a sample of gene list.

FIG. 26 illustrates a sample of an annotation dialog box.

FIG. 27 shows a sample modify permissions dialog box.

FIG. 28 provides an example of a data scaling dialog box.

FIG. 29 illustrates a sample of a dialog box used to select experiments to compare.

FIGS. 30 and 65 show sample difference plots.

FIG. 31 illustrates a sample difference plot with a cursor and text bubble.

FIG. 32 illustrates a sample difference plot with genes having a three-fold difference excluded by the cone.

FIGS. 33 and 71 provides samples of a select profile patterns dialog box.

FIG. 34 shows another sample of a distance plot.

FIGS. 35 and 66 illustrate samples of a gene profile.

FIG. 36 shows an exemplary select experiments to plot dialog box.

FIGS. 37 and 70 show sample variance histograms.

FIGS. 38 and 73 show sample “Enter Correlation Values” dialog boxes.

FIG. 39 shows a sample correlation histogram parameters dialog box.

FIG. 40 shows a sample correlation histogram created using the “no scaling” and the “by Shape (Pearson)” parameters.

FIG. 41 shows a sample “Classify Experiments” dialog box.

FIG. 42 shows a sample classification histogram created using the “adjust scales” scaling procedure and the data displayed in the “Classify Experiments” dialog box.

FIG. 43 shows a sample select reference state dialog box

FIGS. 44 and 68 show samples of the cluster tree analysis view.

FIG. 45 shows a sample the SRS Interface in Simple Mode.

FIG. 46 shows a sample software SRS Interface in Detail Mode displaying a completed query and a database entry.

FIG. 47 shows a sample of the import dialog box define new experiment class tab.

FIG. 48 shows a sample of the import dialog box existing class tab.

FIG. 49 shows a sample change configuration dialog box.

FIG. 50 shows a sample remove experiment class dialog box.

FIG. 51 shows a sample remove experiments dialog box.

FIG. 52 shows a sample point (gene) plotted in three dimensions.

FIG. 53 shows a sample of three experiments plotted in 3 dimensions.

FIG. 54 shows squashing the cigar along its side to best preserve its shape.

FIG. 55 show an exemplary flow diagram for the software.

FIG. 56 illustrates an exemplary program process for analyzing uncharacterized samples.

FIG. 57 illustrates an exemplary program process for analyzing characterized samples.

FIG. 58 shows an exemplary program process for analysis of different groups of data.

FIG. 59 illustrates an exemplary flow diagram for the import process.

FIG. 60 shows an exemplary flow diagram for a second embodiment of the process shown in FIG. 56.

FIG. 64 provides an example of a data normalization dialog box.

FIG. 69 illustrates comparing profiles.

FIG. 72 shows a sample distance plot.

FIG. 74 shows a sample classification histogram.

FIG. 75 shows consistent selection of data points in all views.

FIG. 76 shows direct access to SRS.

FIGS. 77-80 and 82-83 illustrate samples of the SRS interface window.

FIG. 81 illustrates the results of the SRS search shown on the analysis views.

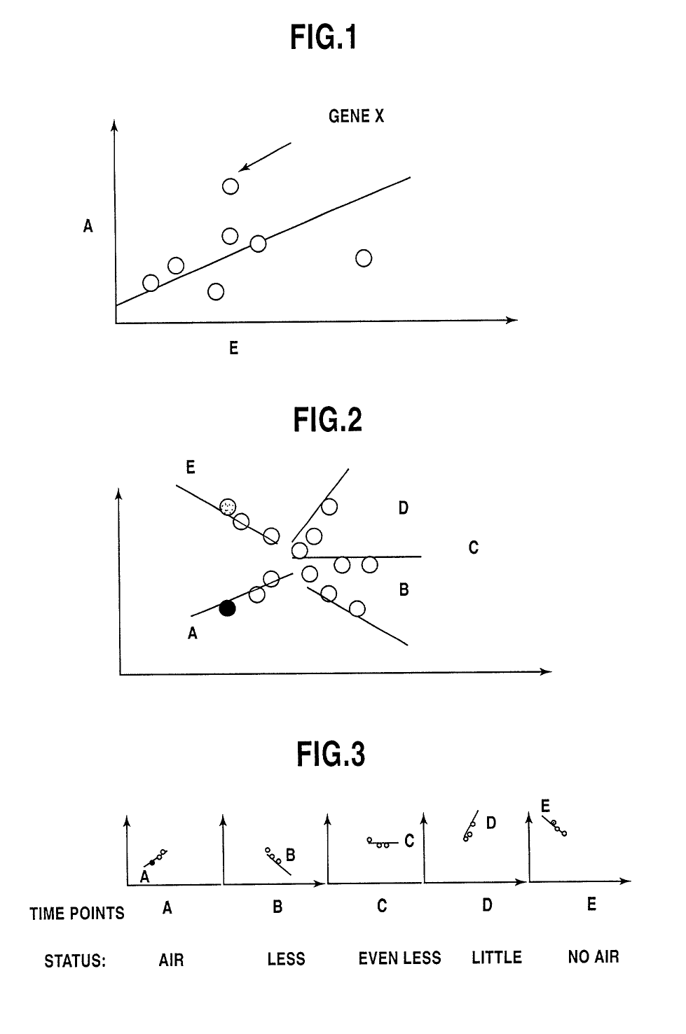

### DETAILED DESCRIPTION OF THE INVENTION

### Introduction

In expression profiling experiments on arrays known DNA fragments are spotted on a solid support as arrays, hybridized with RNA (i.e. cDNA) mixtures as obtained from samples (e.g. tissue samples) and analyzed with respect to the differences in signal strength that reflects the abundance of the various RNA molecules and thus the expression of each gene. Such an analysis may be performed on a chip which would then manifest one form of the frequently discussed ‘DNA Chip’ or on other matrices (e.g. nylon filters). This technology enables the researchers to generate massive data volumes on many individual genes that potentially contain information on networks of co-acting, interacting or co-regulated gene sets. The extraction of this information is by no means trivial since 1) the source data signals usually contain a high level of noise reflecting the problems with experimental reproducibility of such experiments and 2) data volumes generated are usually beyond those efficiently handled and analyzed with standard bioinformatics approaches and manageable by human comprehension.

### Overview

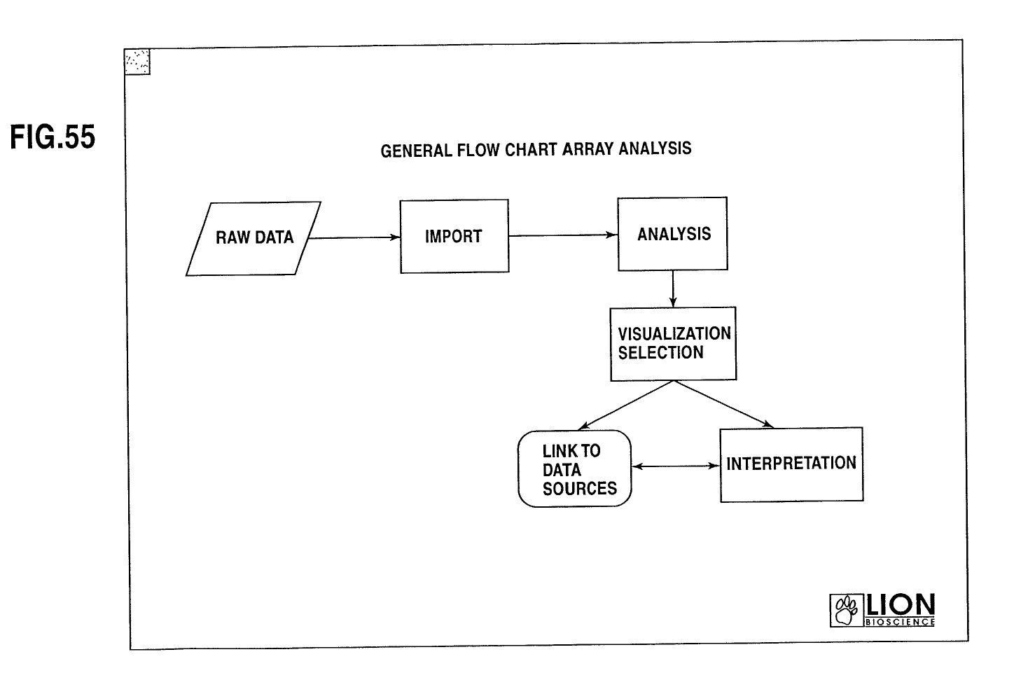

FIGS. 55-60 provide functional flow charts for the present invention. The general flow chart for the software is illustrated in FIG. 55. This figure shows raw data, typically generated from experiments, being imported. The raw data may be in the data format required by the program prior to being imported or may be converted into the required form as part of the data importation process. After importation, the raw data is in the required format and accessible for analysis. In the analysis block a user may select the data to analyze, typically from one or more related experiments. In this block the user may also select one or more analysis tools to use to evaluate the data. The visualization section receives the analyzed data and then displays the analyzed data. The user may interpret the displayed data directly or may select additional analysis and/or visualization tools to interpret the data. Alternatively, the software in some embodiments may be programmed to automatically, filter the data and/or perform a variety of analysis to display the data in an easy to interpret format. In other embodiments the software could interpret the data using an expert system. The user or the program may access or link to other data sources to obtain additional information on the gene, compound, cell, sequence, virus, or substance related to a specific data point.

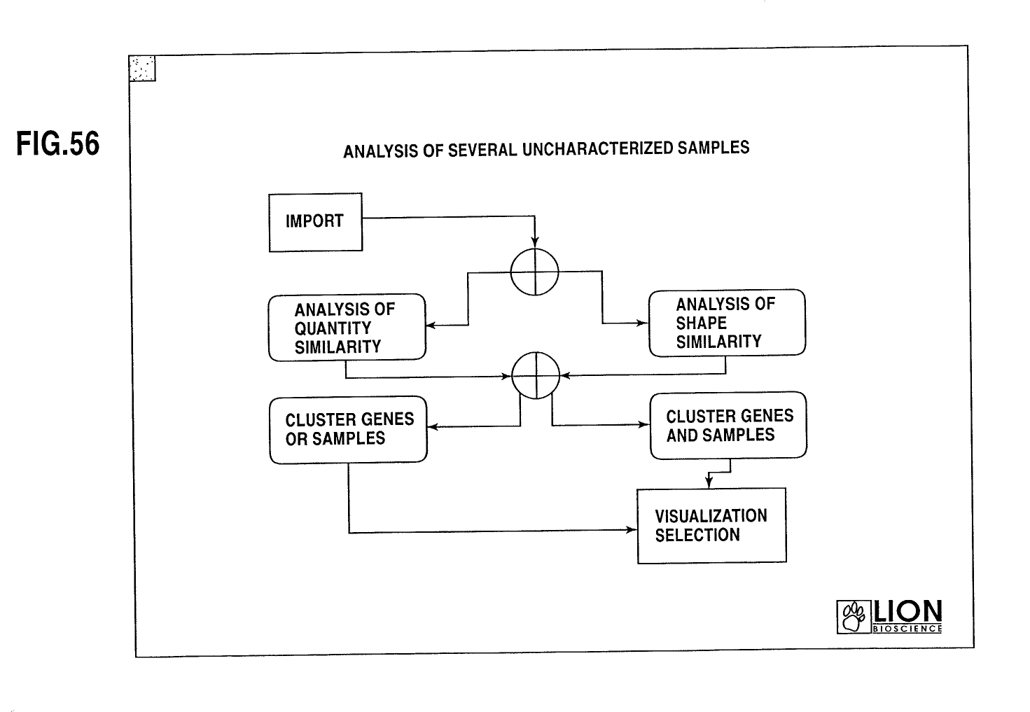

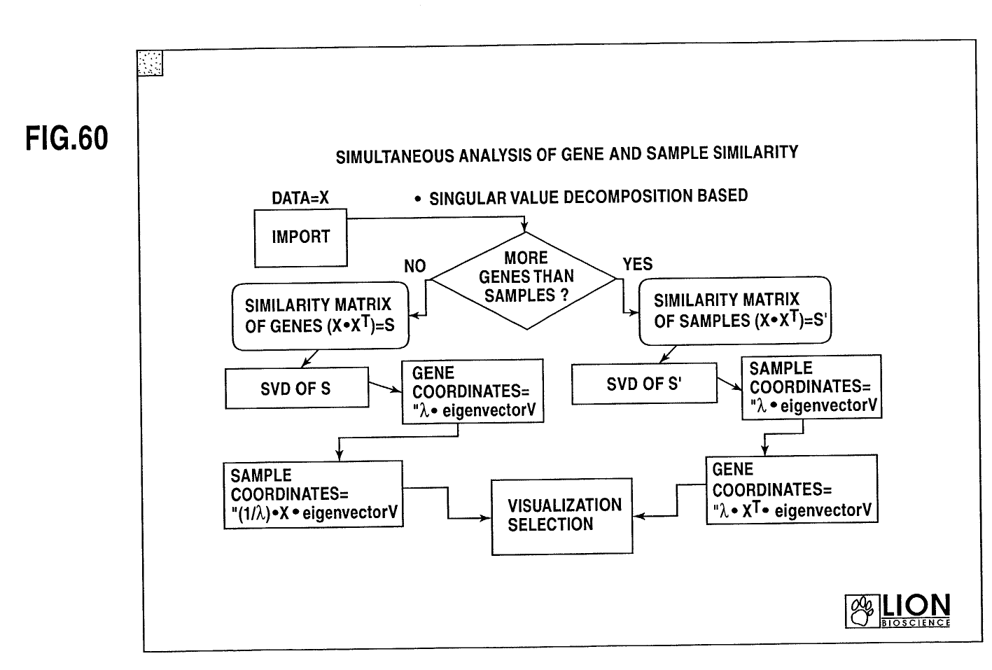

FIG. 56 illustrates an exemplary program process for analyzing uncharacterized samples. In this flow chart the data and/or samples are analyzed on the basis of similarity and then similar samples or genes may be clustered. FIG. 60 shows an exemplary flow diagram for a second embodiment of the process shown in FIG. 56.

The second embodiment compares the number of genes, cells, viruses, sequences, or substances (known variable in experiment) to the number of samples. If the number of samples is larger, then a sample similarity matrix is formed from the data. When the number of known variables is larger, a variable similarity matrix is formed from the data. Thereafter, a singular value decomposition (SVD) of the matrix formed takes place. The sample and known variable coordinates are determined based on the eigenvector of the matrix formed. These coordinates are then utilized in the visualization section of the software.

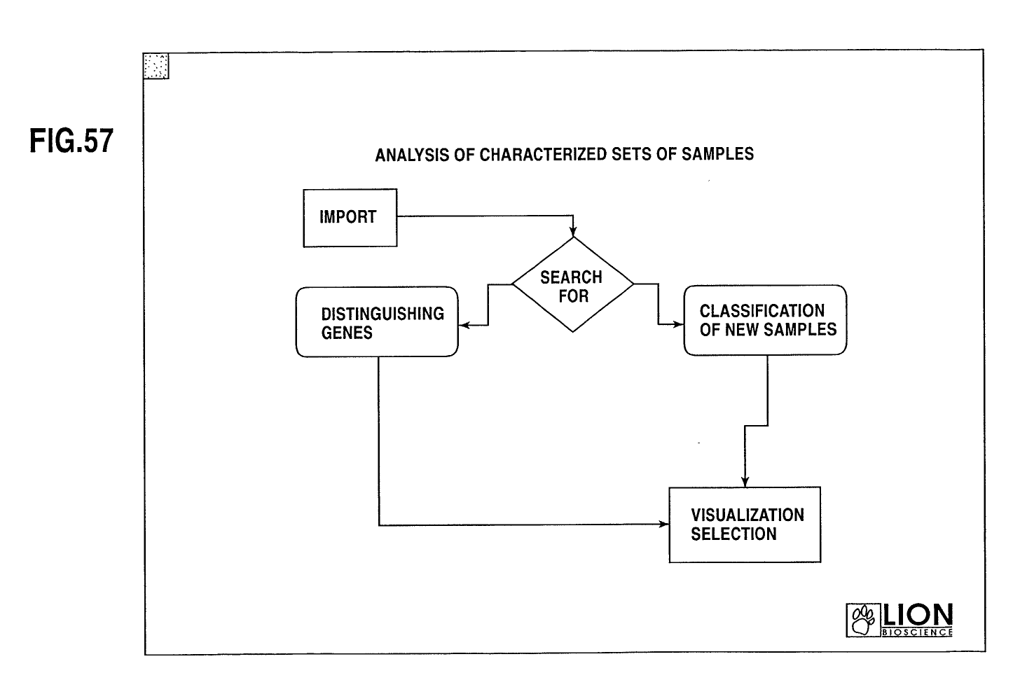

FIG. 57 illustrates an exemplary program process for analyzing characterized samples. In this flow chart the data and/or samples are analyzed to find distinguishing genes or samples. Alternatively, the data and/or samples are analyzed to classify new samples.

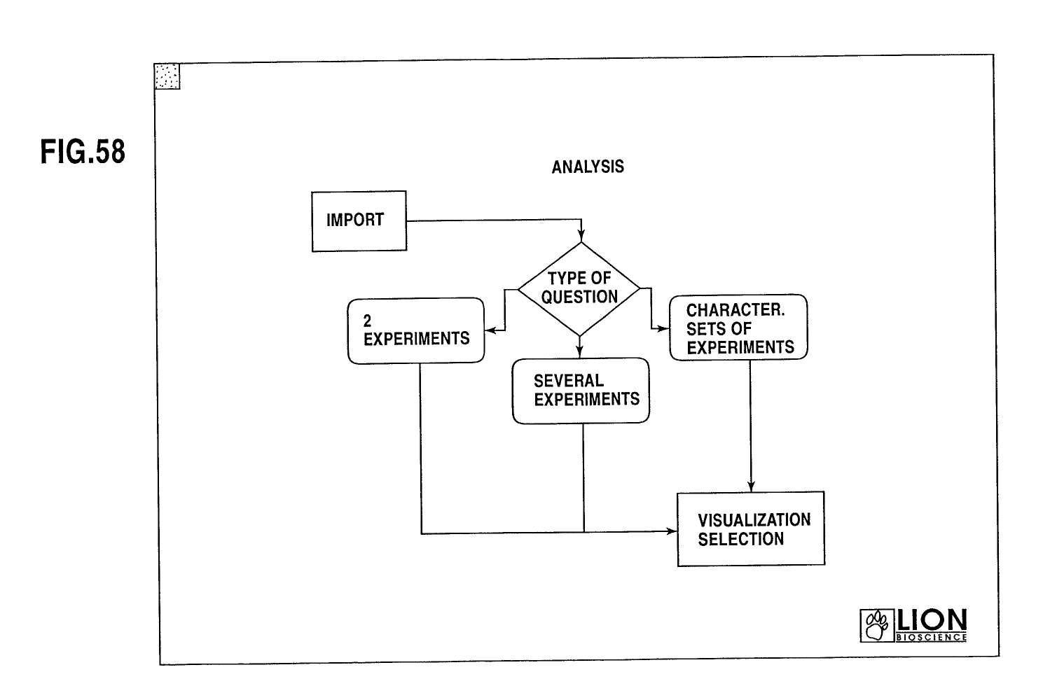

FIG. 58 shows an exemplary program process for analysis of different groups of data. The program allows the comparison of two experiments, several experiments or different sets of experiments.

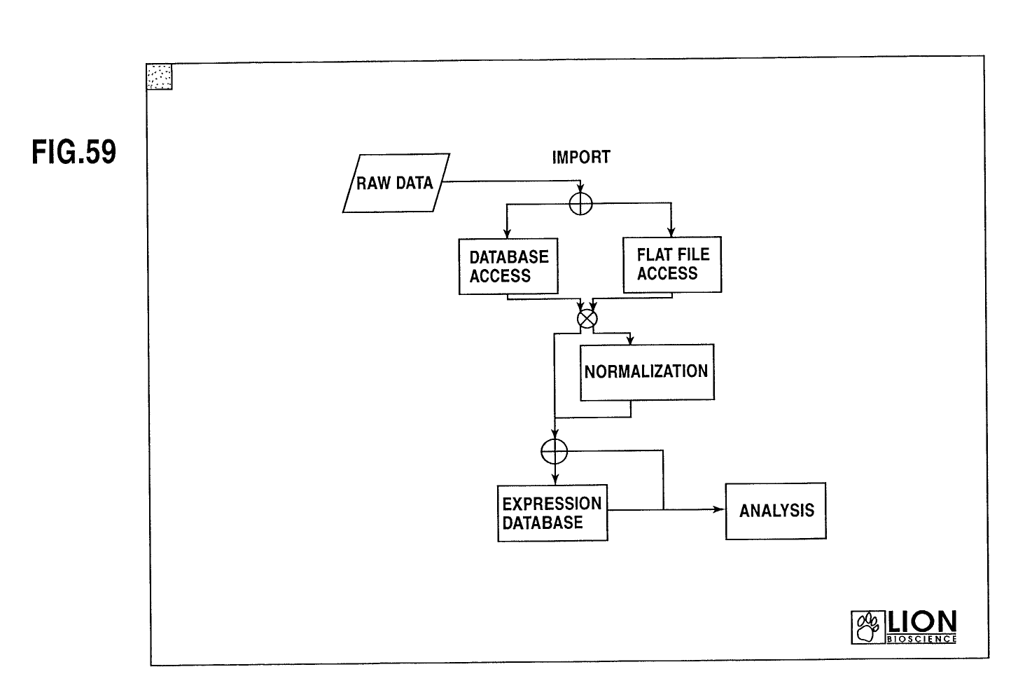

FIG. 59 illustrates an exemplary flow diagram for the import process.

### System Requirements for an Exemplary Embodiment

The exemplary embodiment utilizes as a server a PC running LINUX -or- a SGI running IRIX, with 128 MB RAM. Additional software requirements utilized in the optional embodiment described: SRS and CORBA server; SRS objects; and ORACLE 8.X. The preferred client is a networked personal computer. One of ordinary skill in the art of computer systems will recognize that the invention could be operated on other computer systems running alternative software.

### Description of the Exemplary Embodiment

### User Interaction with Software

### Selecting Menu Items

The user interacts with software in a very standard way. Menus are opened with a click and hold mouse action. Moving the mouse through the menu will highlight individual menu items and releasing the mouse button will select the highlighted item. It is also possible to click on the first menu item to highlight it, and then use the arrow keys to scroll through the list and thus moving the highlighting bar.

Multiple adjacent menu or list items may be selected by highlight the first item and then holding down the shift key while highlighting the last item, this action will highlight all the items in between the first and the second item highlighted. Multiple non-adjacent menu or list items may be selected by highlight the first item and then hold down the Ctrl key while highlighting all the others.

### Mousing

The left mouse button is used for selecting genes in analysis views and highlighting items in all lists and menus. Right-clicking on items, e.g. projects and genes in the gene list, will open a context specific command menu in which you can make selections. The right mouse button is also used for zooming into the analysis views: click and drag the right mouse button around the area you wish to zoom into.

### Short-Cuts

Command menus list short-cut keys for performing actions using the keyboard instead of the mouse. Exemplary short-cuts are show in Table III:

TABLE III
Short-cuts

| Action | Key-stroke |
|---|---|
| Select highlighted items in gene list window. | Ctrl + Enter |
| Reset selection in gene list window. | Ctrl + R |
| Show profiles of genes highlighted in gene | Ctrl + P |
| list window. | |
| Close application. | Ctrl + Q |

### Getting Help

### Opening On-line Help

From the command menu bar, select Help>Table of Contents. You will see the table of contents for the on-line help.

### Application Overview

The software provides tools useful in a variety of settings, from numerical gene expression data to biological interpretation. The software employs a variety of statistical algorithms, interactive viewers, links to bioinformatics systems and the capacity to manage large volumes of data enabling the identification of a selection of candidate genes meeting specified criteria.

### Product Overview

### Statistical Data Analysis and Gene Clustering

The software incorporates a variety of statistical tools. They have been implemented and optimised for performance in the software system. These algorithms include variance analysis, variants of principal component analysis, cluster tree analysis and correlation analysis.

### Interactive Graphical Visualization

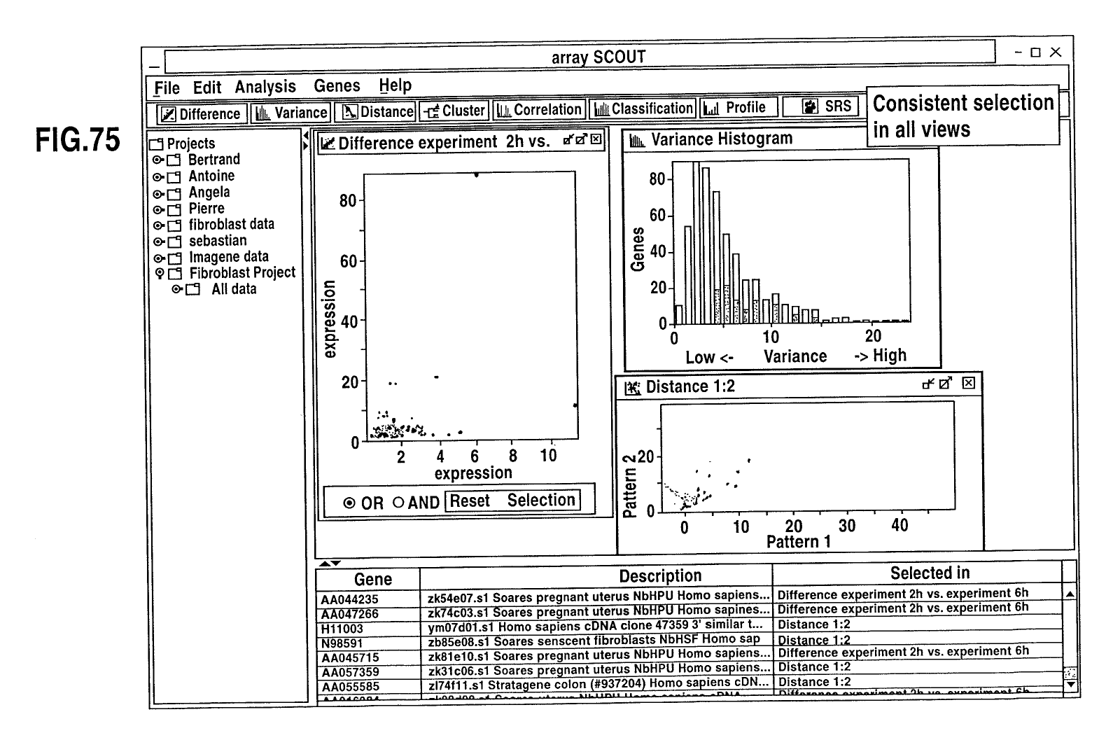

Expression data and analysis results are vividly displayed with interactive viewers allowing diverse aspects of the data to be highlighted. Properties can be plotted and color-coded to display multiple levels of information simultaneously. Views cross- communicate; selections made in one view will remain highlighted when another view is opened. FIG. 75 illustrates this concept of consistent selection in the open views.

### Integration with Scientific Databases

Once a set of regulated genes has been identified, a way to explore and investigate these genes in-depth is needed. Gene classification, patent situation, functional similarities and other aspects of the gene set can be queried via public as well as from proprietary in-house databases. One commercial product that can be used to perform this function is SRS sold by Lion Biosciences.

### Pathway Assignment

Information on biological pathways is essential to interpret co- regulated gene clusters. The software provides easy interaction with several pathway databases via, for example, the SRS technology platform.

### Interface with Sequence Analysis Package

The software system capabilities are enhanced by its ability to interface with a sequence analysis system. One example of such a system is the bioSCOUT system also sold by Lion Bio Sciences. These systems enable the elucidation of detailed information about the genes, or subsets of genes, based on deduced and calculated properties, and may provide summarized feature reports on each gene. If additional information is required, a suite of bioinformatics applications may also be available these sequence analysis systems that can enable further investigations.

### Data Management

The software is designed to handle large data sets. Data formats which are compatible include GATC database format, tab delimited ASCII format data files and output from BioDiscovery's ImaGene® software.

Raw data is stored as an “experiment”. Comparable experiments can be grouped into an “experiment group” within a “project” which can contain user annotations and a complete list of the included experiments. Users work within projects containing experiment groups and gene lists.

### Logging In

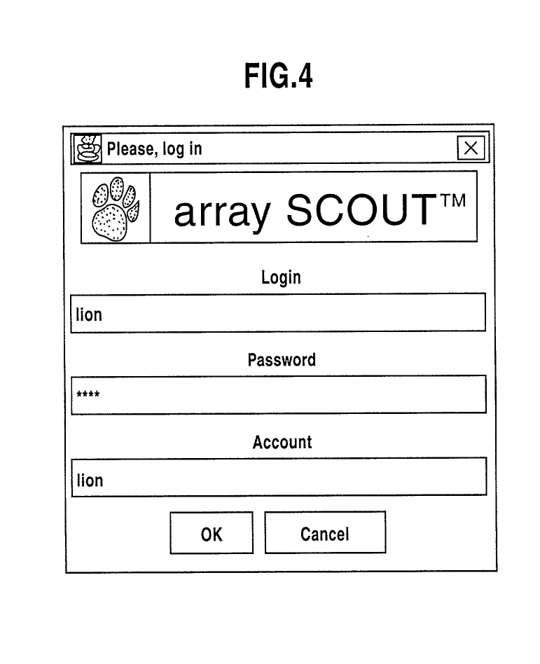

Start the software program. The log in window will open. An exemplary login window is shown in FIG. 4. Enter the required information, for example, your user name, password and account, then click on the “OK” button. If you decide not to log in, click on the “Cancel” button to close the window.

### Interface

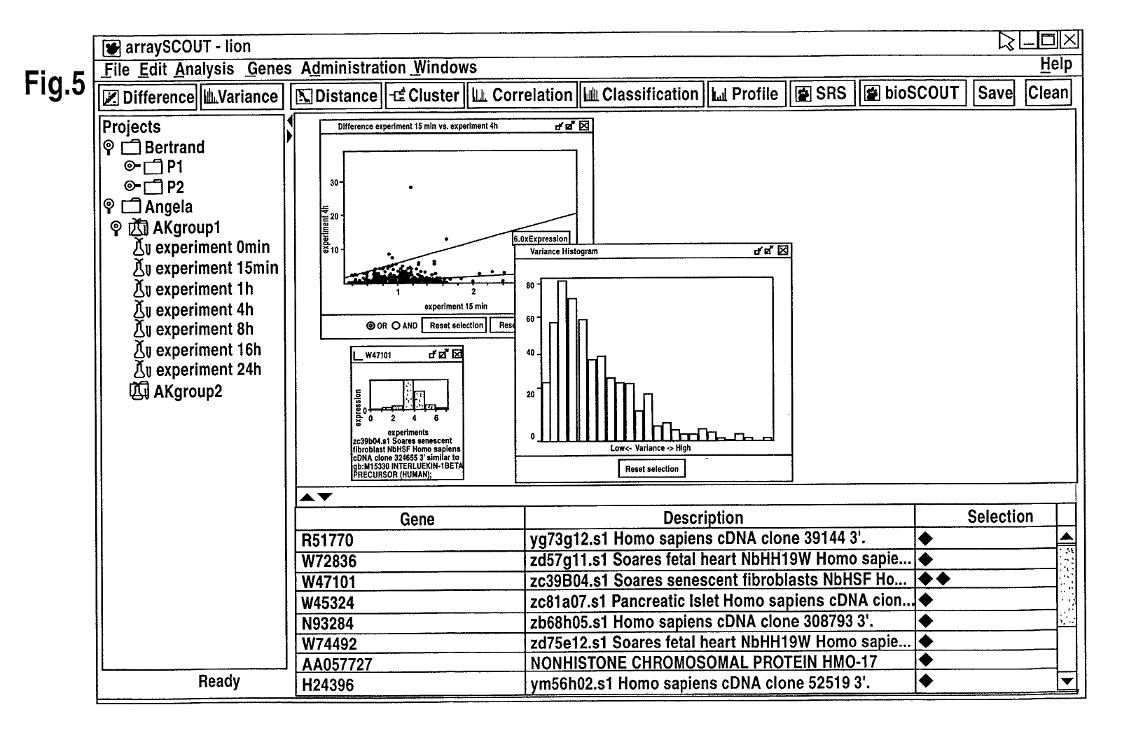

The whole application may be maintained in one interface window which can be resized, minimized and maximized. There are standard command menus and a tool bar with short-cut buttons. The interface may be subdivided into three windows. An exemplary interface is provided in FIG. 5.

### Command Menus

At the top of the interface are the command menus: File, Edit, Analysis, Genes, Administration, Windows and Help. The contents of these menus will be explained as the process of using software is described. To select an item from a menu, click on the menu name to open it, use the mouse arrow to highlight the selection and then click again to select it.

Command menus are also available by right-clicking over an object to manipulate. For example, by right-clicking on a project folder, a menu opens with options including creating a new experiment group within that folder. Click in the menu to select an item.

Menus are context sensitive, so listed items in the menus aren't always available.

### Tool Bar

The tool bar provides shortcut buttons for all the analysis filters; other applications, for example, “SRS” and “bioSCOUT”; “Save”; and “Clean”. Exemplary tool bar buttons are listed in Table IV.

[image]

[image]

[image]

### Windows

### Project List Window

The Project List Window is on the left side of the interface. It displays the Project List in which projects, sub- projects, experiment groups, experiments and gene lists will be displayed in a hierarchical tree of folders.

### Analysis Window

The largest section of the default interface is the Analysis Window which contains the analysis views and the SRS interface. The internal frames cannot be moved out of the analysis window.

### Gene List Window

The Gene List Window is on the bottom of the interface, below the Analysis Window. It lists the genes you have selected in the analysis views.

### Adjusting the Interface and Windows

You can move about in the windows, resize the software interface and internal windows and zoom into analysis views as you wish. Table V illustrates various ways of adjusting the interface

[image]

[image]

[image]

### Preparation for Analysis

### Organizing Your Data in the Project List

The Project List is a hierarchical listing of all the projects and data owned by the users of software. You will create a new project and within the project a new experiment group. The project will provide an environment to work and store results in. The experiment group will house all the experiments that you want to compare.

### Create A New Project

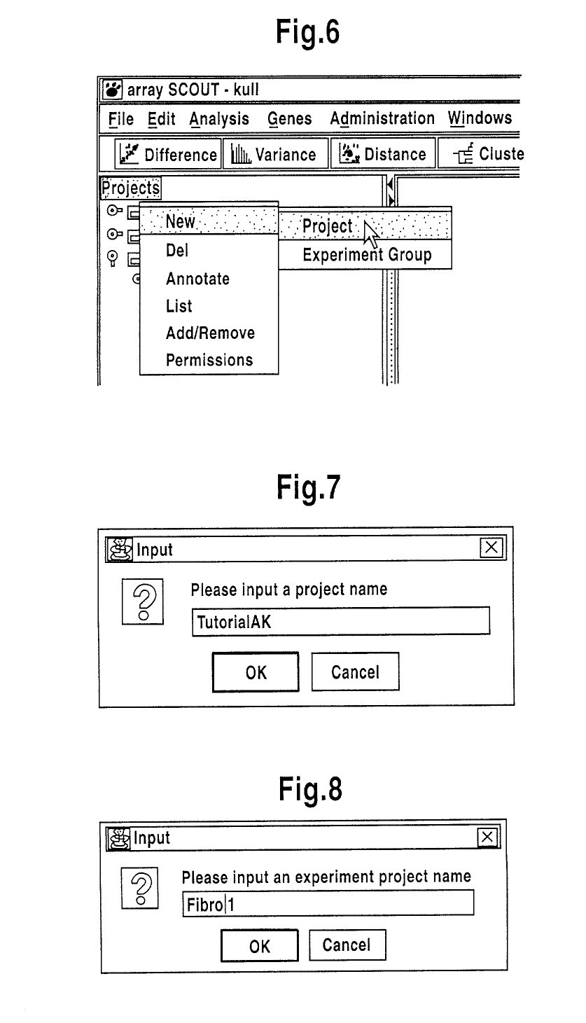

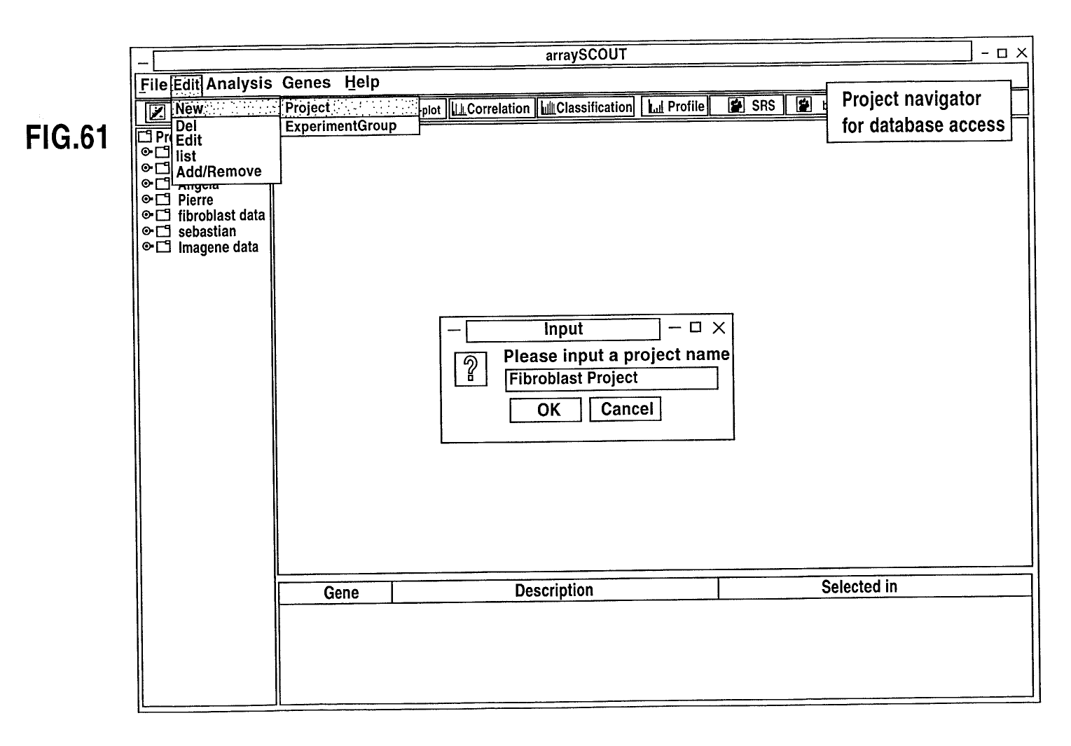

In the left-hand window (the Project List), highlight the word “Projects” and choose Edit>New>Project from the menu bar (or right-click on the selection and choose New>Project from the menu). This process is illustrated in FIGS. 6 and 61.

A dialog window will open, enter the name for the new project, for example, “TutorialAK” as shown in FIG. 7. Click “OK”, the new project will appear in the Project List.

### Create An Experiment Group

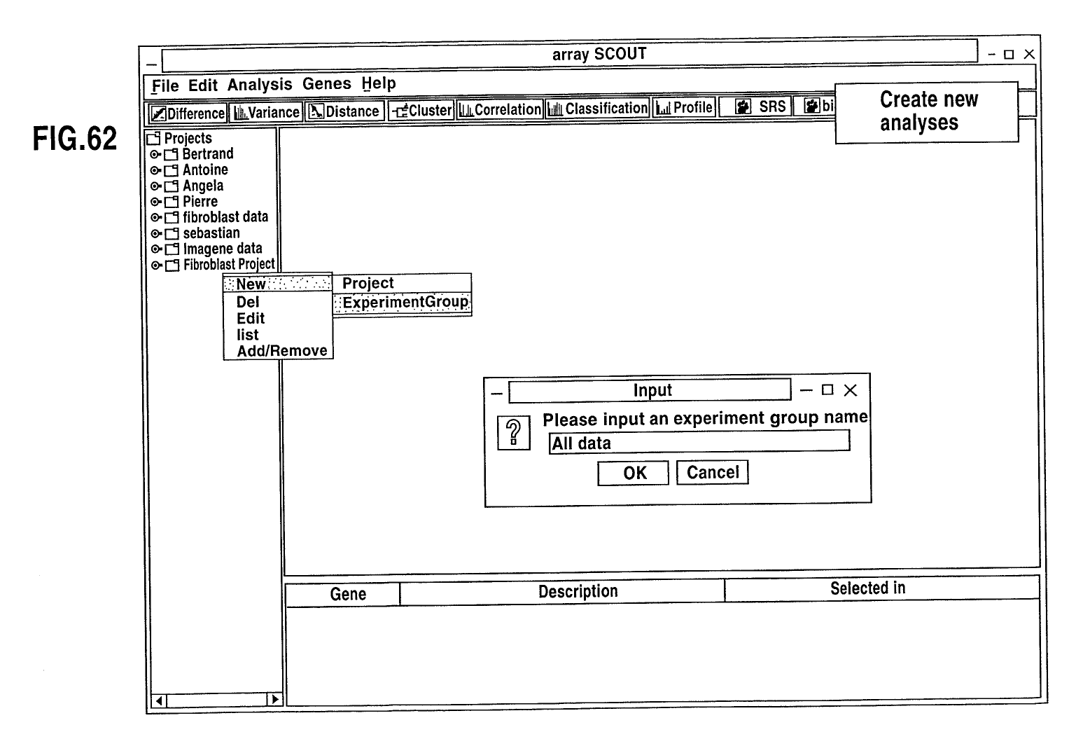

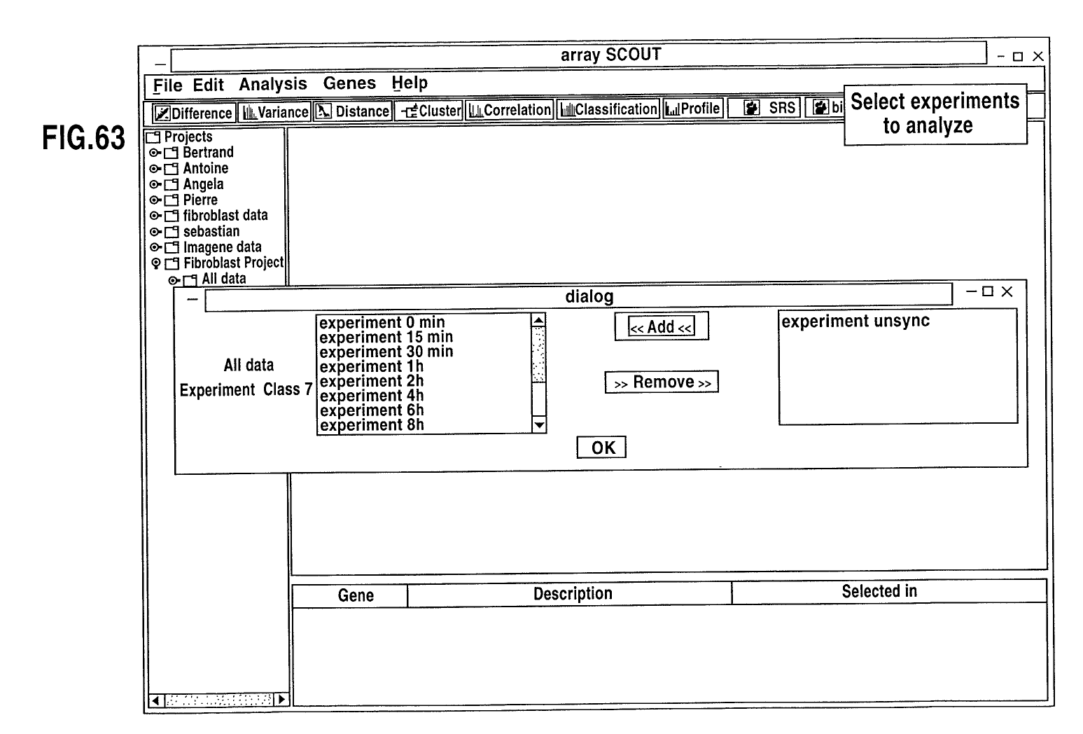

Highlight the project in the Project List and choose Edit>New>Experiment Group from the Edit command menu (or right-click on the project and choose New>Experiment Group). A dialog box will open. An exemplary dialog boxes are shown in FIGS. 8 and 62. Enter the name for the experiment group in the text field, for example, “Fibro1” and click “OK”. The new experiment group will be listed in the Project List. At this point the experiment group is just an empty folder. You must now add the experiments you wish to include in the analysis.

Highlight the experiment group, for example, “Fibro1” and choose Edit>Add/ Remove from the Edit command menu (or right-click on the experiment group and choose Add/Remove). A dialog box will open, select the class, for example, “fibroblast”. Alternatively, you can highlight the first and use the arrow keys to scroll down the list and automatically move the highlighting bar. Click “OK”.

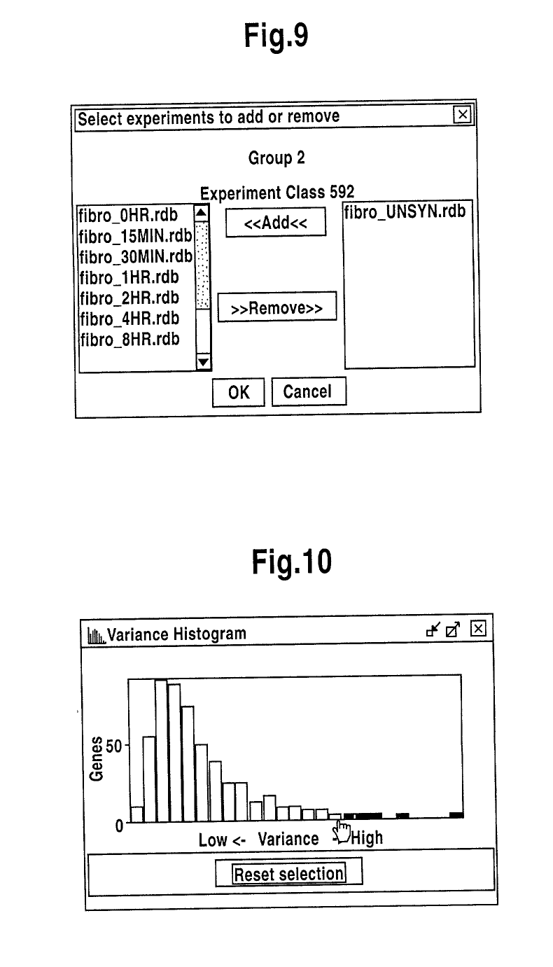

A second dialog box will open listing the available experiments. An example of this dialog is illustrated in FIG. 9. Highlight the experiment to add, for example, “fibro_{—}0HR.rdb” by clicking on it. Click on the “Add” button to move it into the “Add” column on the left. Repeat these steps to add additional experiments, for example, fibro_{—}15MIN.rdb, fibro_{—}30MIN.rdb, fibro_{—}1HR.rdb, through fibro_{—}24HR.rdb. In some embodiments it may be important to add the experiments in the correct numerical order. Click “OK”, the experiments will be copied into your experiment group.

### Analysis

The data utilized in this exemplary analysis are time points taken from a synchronized population of fibroblast cells. This exemplary analysis identifies cyclins that are markedly up regulated during the time course. The above exemplary analysis is utilized for explanation only; one of ordinary skill in the art would understand, based on this example, how to use the invention in the analysis of other cells and related genes.

### Plots and Histograms

One analysis tool provided by the software is a Variance Histogram. To use the Variance Histogram, select an experiment group in the Project List. Click on the “Variance” button in the tool bar. The “Choose Experiments to Plot” dialog box will open. Click “OK”, including all the experiments. The Variance Histogram will appear. An example of a Variance Histogram is illustrated in FIG. 10. Select the ten histogram bars in the right shoulder of the histogram by mousing over them and clicking. The genes represented by these bars show a high level of variability in expression levels in these experiments.

The genes represented in the selected bars are now listed in the Gene List at the bottom of the interface and that there may be a symbol having a color corresponding to the color of the analysis window in the right-hand column (the “Selected in” column) of the Gene List table. These genes represent the first selection of potentially up regulated genes. Next, start a Distance Plot analysis, which clusters the data on their principal components, to further refine the selection.

Click on the “Distance” button in the tool bar. A parameters dialog box will appear. Click “OK” to use the default scaling parameter, “adjust shift (avg=0)”. This centers the data on the (0,0) coordinate.

A second dialog box will open displaying two columns of histograms; one for the x-axis and one for the y-axis. Two default histograms are already selected: the first in the x-axis column and the second in the y-axis column. Click “OK” to accept the default choices.

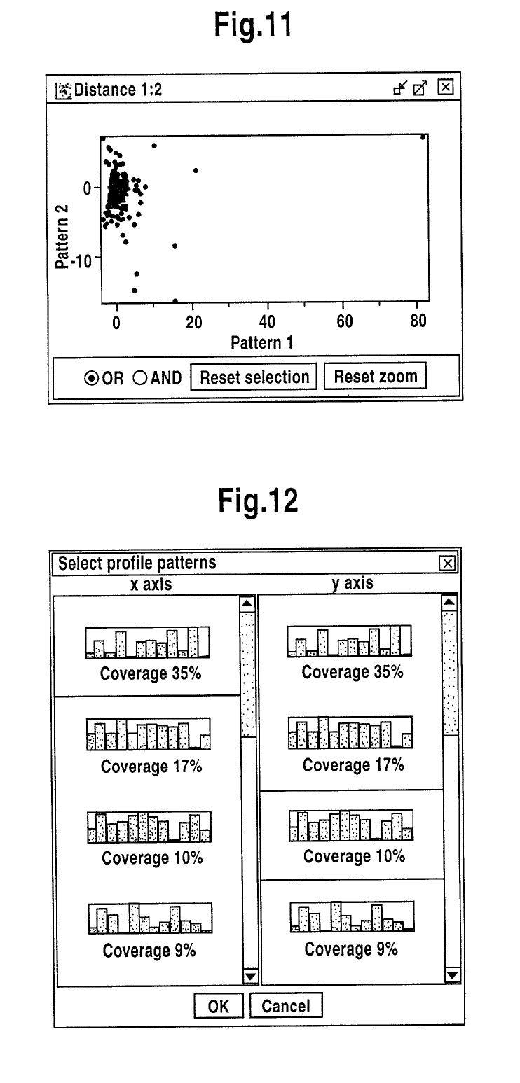

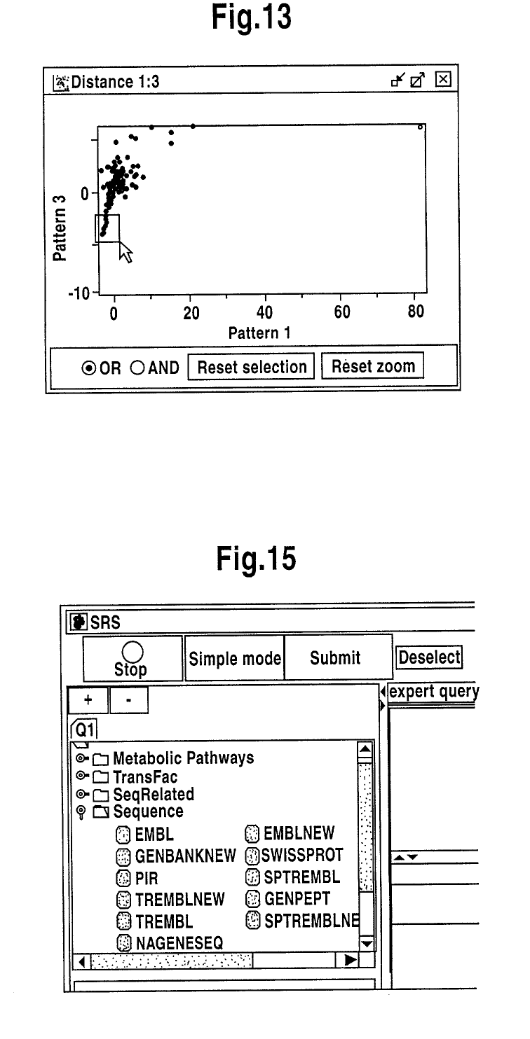

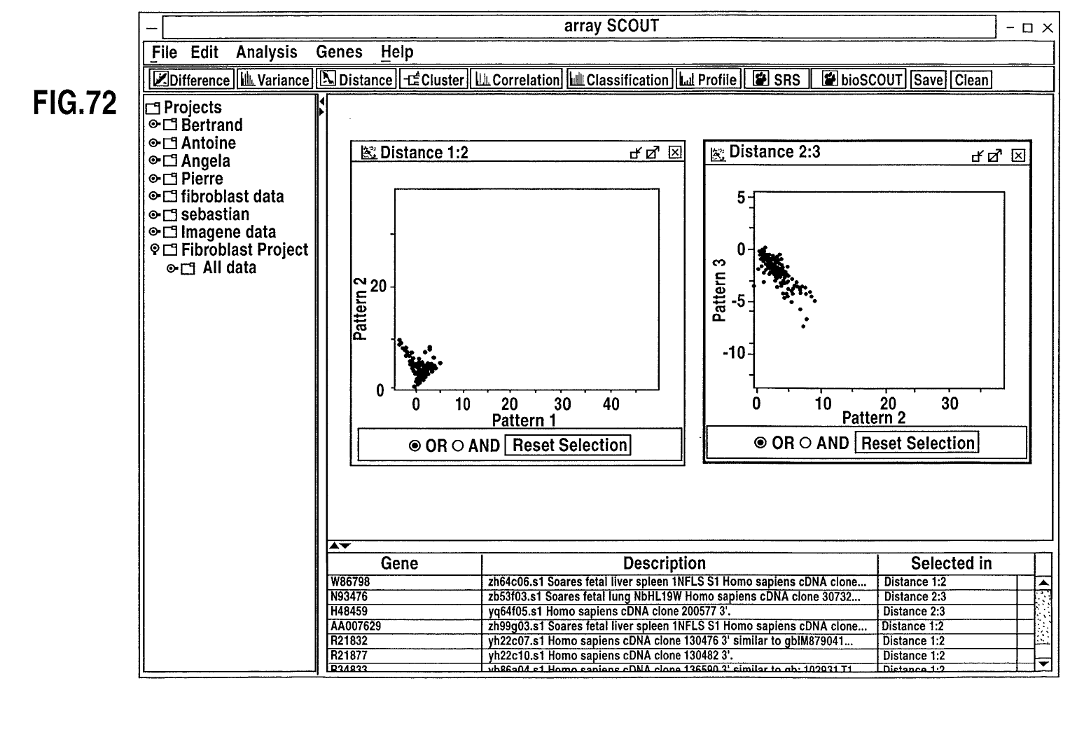

FIG. 72 illustrates sample distance plots and FIG. 11 illustrates a plot using the default settings. The plot will open, the frame of the plot may be of a different color than that of the Variance Histogram. FIG. 13 provides an exemplary plot using user selected settings. Again, click on the “Distance” button in the tool bar. A parameters dialog box will appear. Click “OK” to use the default scaling parameter, “adjust shift (avg=0)”. This centers the data on the (0,0) coordinate.

A second dialog box will open displaying two columns of histograms; one for the x-axis and one for the y-axis. These dialog boxes are shown in FIG. 12. This time click on the third histogram in the y-axis column (right column) to select it and click “OK” to accept these new choices.

The plot will open, notice that the cluster shown in FIG. 13 has a different shape than in the first Distance Plot shown in FIG. 11. Zoom into the bottom tail of the Distance Plot by right-clicking and dragging around the area you want to zoom into. Select the genes that lie above the cluster and in the bottom tail of the cluster by clicking and dragging a box around them with the mouse.

### The Gene List

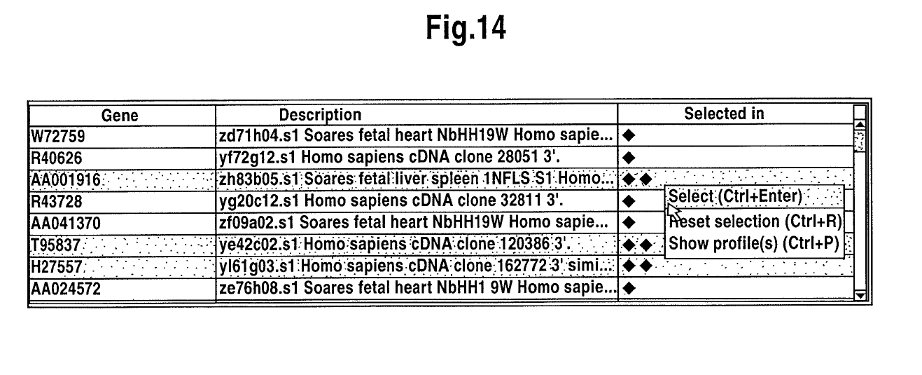

The selected genes are now also listed in the Gene List shown in FIG. 14. The genes that were selected in both analysis views may be of interest. These genes are identified by two diamonds. In some embodiments the color of the diamond corresponds to the related analysis window frame color, in the “Selected in” column of the Gene List. You can separate these genes from the rest by selecting them in the Gene List itself.

Move to the top of the Gene List shown in FIG. 14 using the scroll bar to the right of the window. Highlight the first gene in the list that is selected in both views by clicking on it. Holding the Ctrl button down on your keyboard, click with the mouse on all the other genes selected in both views to highlight them too; use the scroll bar to move down the list. When all the desired genes are highlighted in the Gene List, right- click on it and choose “Select” from the menu.

The highlighted genes will now be selected in the Gene List. In some embodiments these genes are identified with a red diamond in the “Selected in” column. In the frames of the Variance Histogram and Distance Plot windows, there is a “Reset Selection” button. Click on this button in both analysis views to deselect the genes selected in them. The genes selected in the Gene List will also remain selected in all analysis views. In the preferred embodiment the selected genes are displayed in a color, for example, red so that the user can easily identify the genes of interest in any analysis window.

### Sequence Retrieval System (SRS)

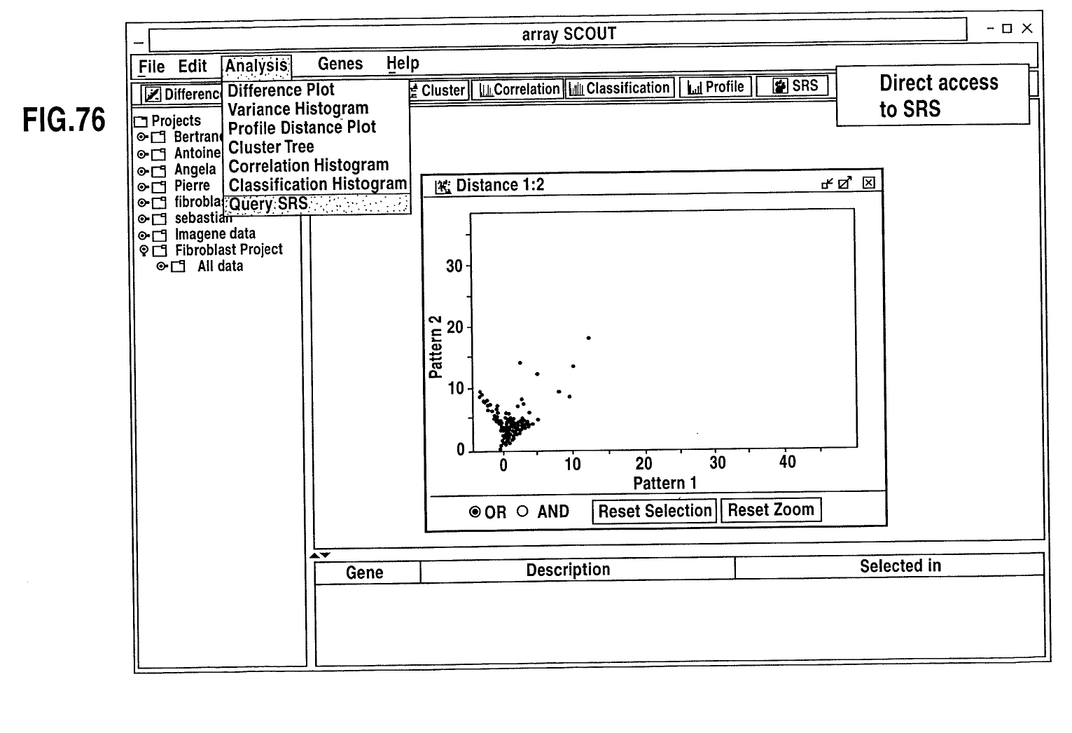

The selected genes have a high level of variance in expression and are not conforming to an average expression profile. To find the genes that are cyclins, you can use SRS or a similar program/system. The details of the SRS system are disclosed in PCT/EP99/10383 incorporated herein by reference. This feature of the software is illustrated using SRS, however, one of ordinary skill in the art could implement the program with similar systems. FIG. 76 illustrates this direct access to SRS.

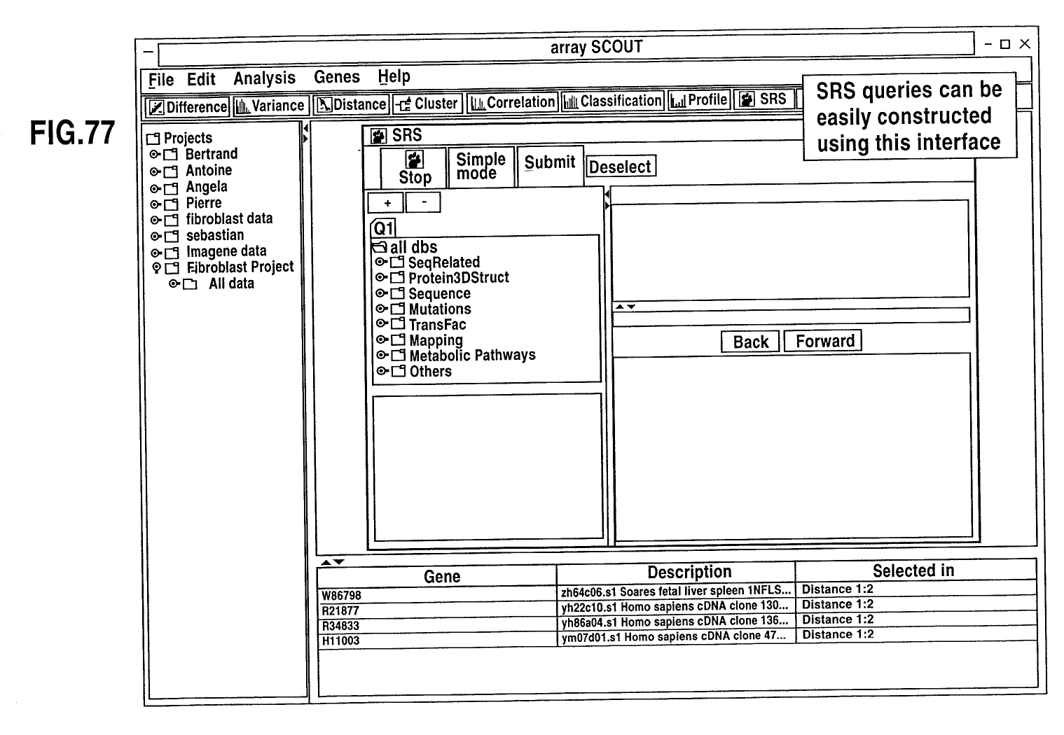

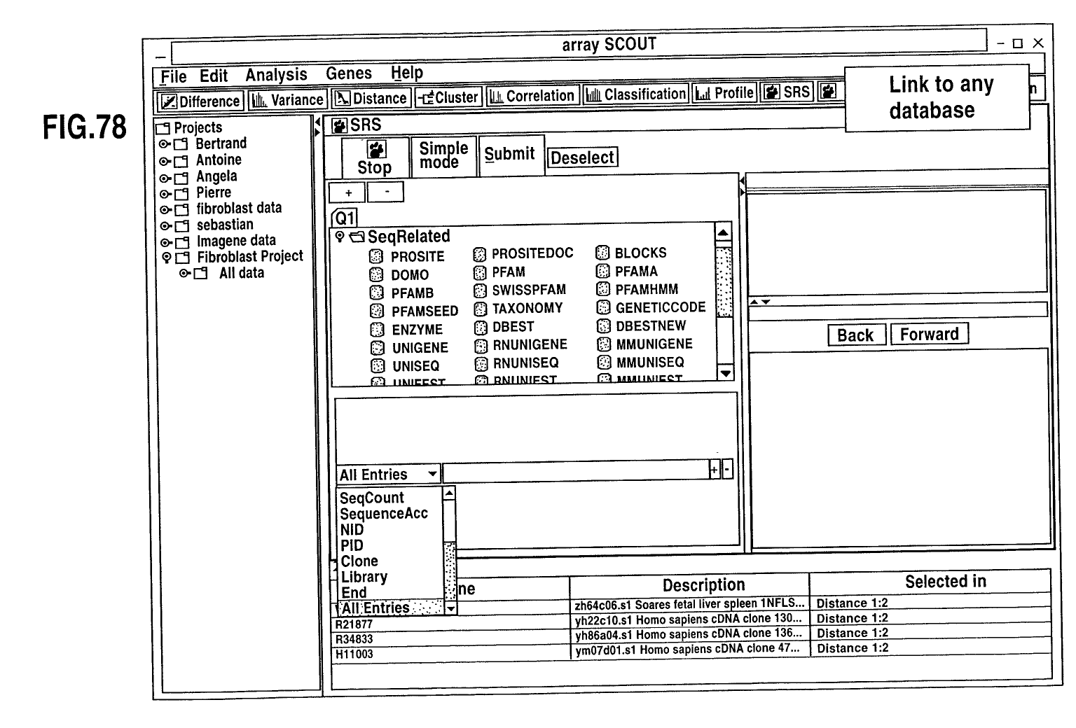

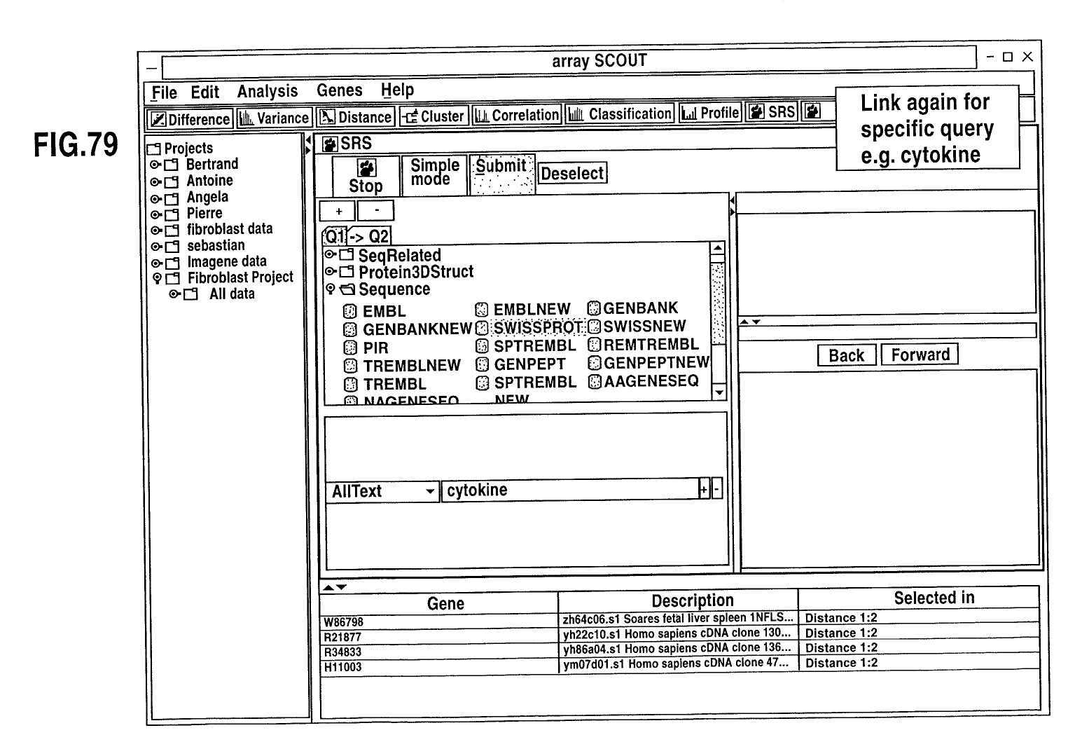

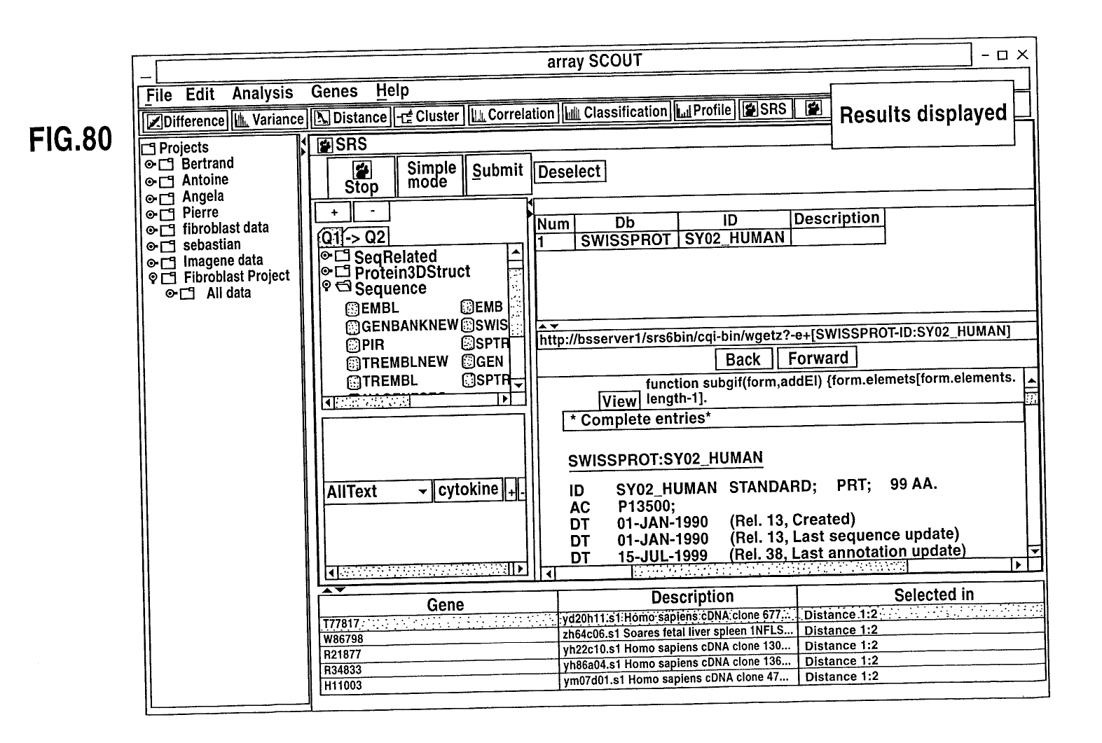

Click on the “SRS” button in the tool bar. The SRS interface window opens. This window is illustrated in FIGS. 15 and 77-80. Click on the “Detail mode” button. The interface will change and list some folders in a tab labeled “Q1”. Click on the toggle switch next to the folder called “Sequence” so that the contents of the folder are displayed.

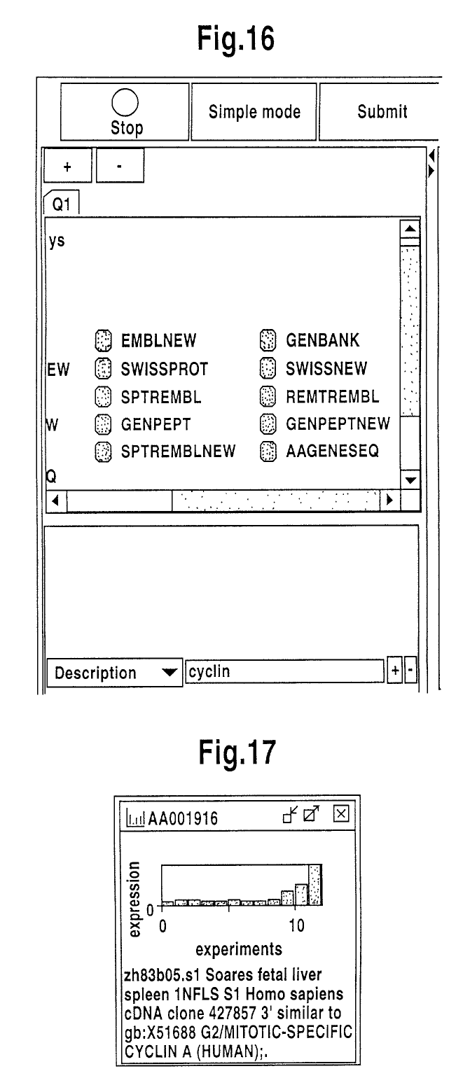

A number of databases may be listed. Hold down the Ctrl key and click on the desired databases to highlight them, for example, “EMBL”, “Swissprot” and “GENBANK”. A blank text field and pull-down menu, listing searchable database entry fields, appears below the Q1 tab when a database is selected. Select the desired database field to search from the menu, for example, the field “Description”. Type in the search term, for example the word “cyclin” in the text field and click on the “Submit” button at the top of the window. This search is shown in FIG. 16.

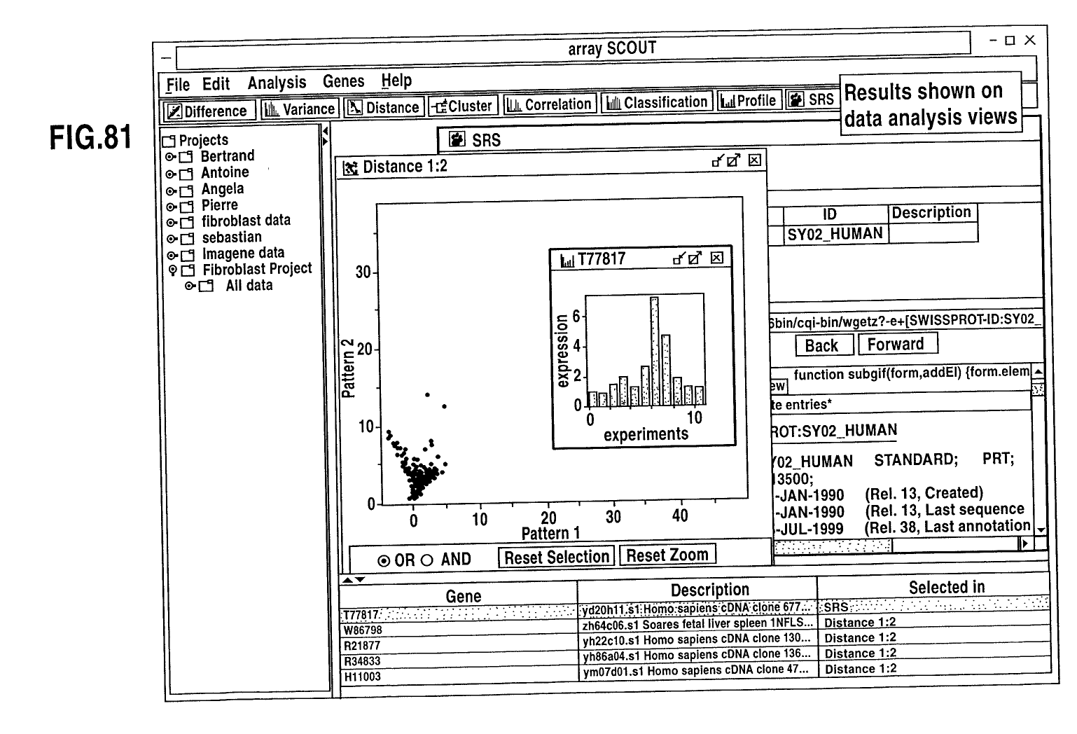

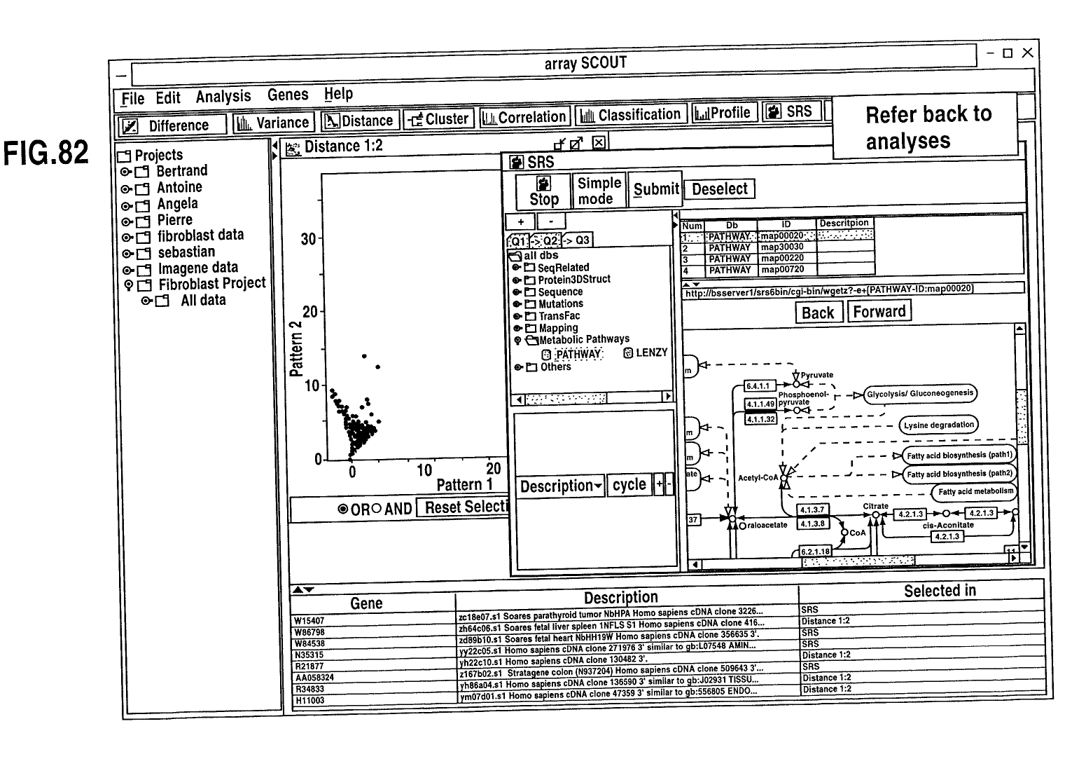

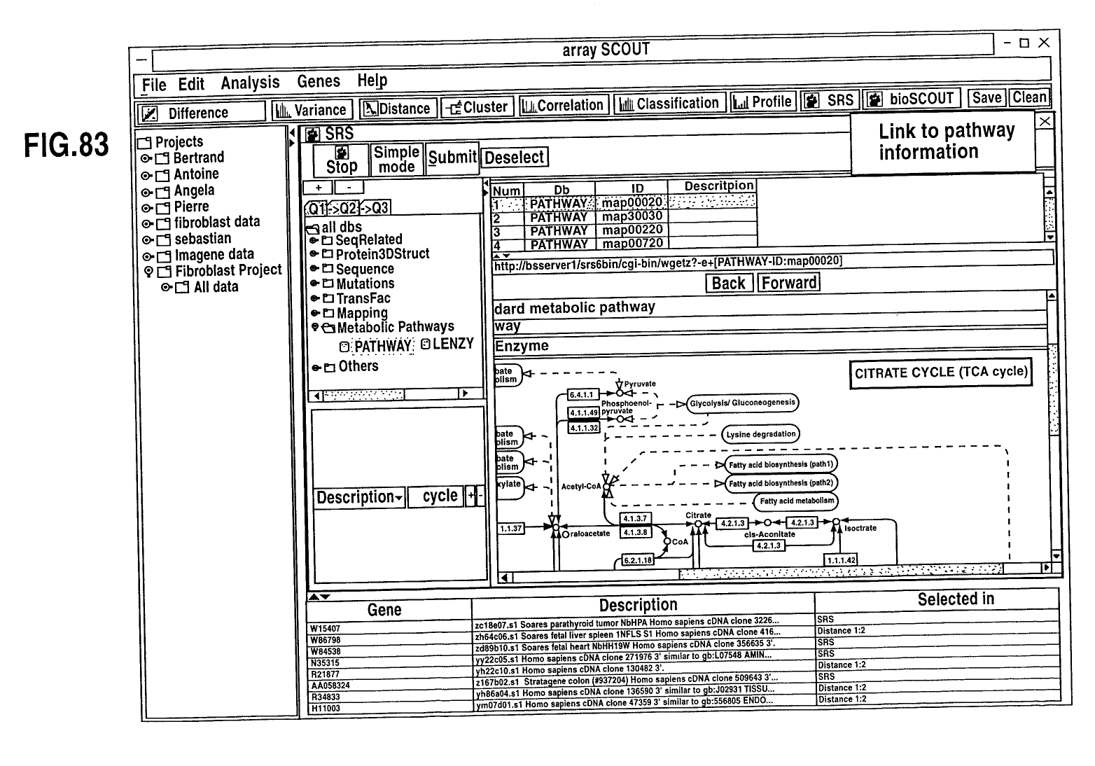

A list of genes from the experiments that match the SRS query will be listed in the SRS window. These genes may be automatically selected in all the analysis views and listed in the Gene List as shown in FIG. 81. Additional information may be obtained on a gene that is selected in both the Gene List and the SRS window, for example, AA001916.

Highlight this gene in the Gene List and click on the “Profile” button in the tool bar. The Expression profile of the gene and its description will appear. The expression profile of the gene and its description for AA001916 are shown in FIG. 17. This gene is up regulated toward the end of the 24 hour cycle and is similar to the G2/Mitotic-Specific CyclinA gene from humans.

### Cluster Tree

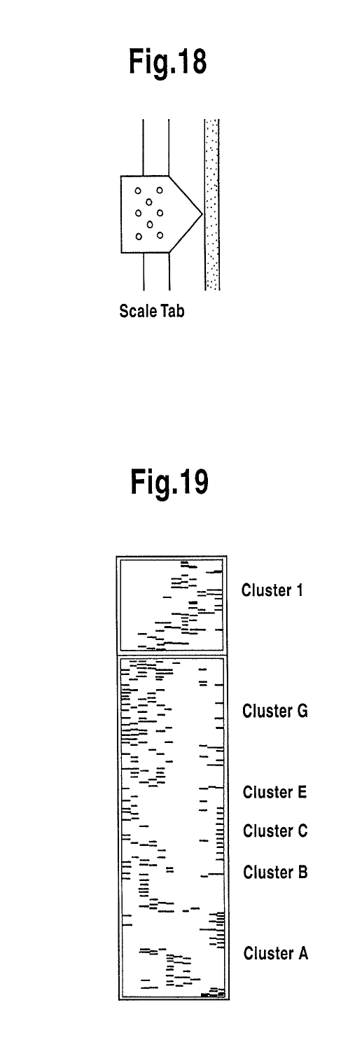

The cluster tree and red/green plot displays genes grouped by expression pattern. Click on the “Cluster” button in the tool bar. Select “Mean of Experiments” as the reference state (this is the default selection). Click “OK”. Enlarge the Cluster Tree Window to the full height of the Analysis Window by moving the mouse over the bottom frame of the Cluster Tree Window. Then click and drag the bottom edge of the frame down and release the mouse button at the bottom of the Analysis Window. Zoom out of the Cluster Tree view by clicking on the vertical scale tab and dragging it toward the bottom of the Cluster Tree Window, stopping just before a scroll bar appears. An exemplary scale tab is illustrated in FIG. 18.

The clusters can now be seen more clearly. An example of a red/green plot for fibroblast data showing Clusters A, B, C, I, J, and K is shown in FIG. 19. Some of the clusters in the fibroblast data, for example, Clusters D, F, and H are not outlined, but fall in between the clusters delimited above (Vishwanath R. Iyer et al., 1999). The analysis of the Cluster Tree is taken from: Iyer, Vishwanath R. et al. (1999) Science 283, 83-87.

### Project List

The Project List is a hierarchical set of project folders. Projects allow software users, working in a multi-user environment, to separate and organize their work. Projects can contain sub-projects, experiment groups and gene lists and can be organized in a hierarchical manner. Users can assign permissions to their projects, determining which software users can access them. Projects can be individually owned or worked in by a group of users.

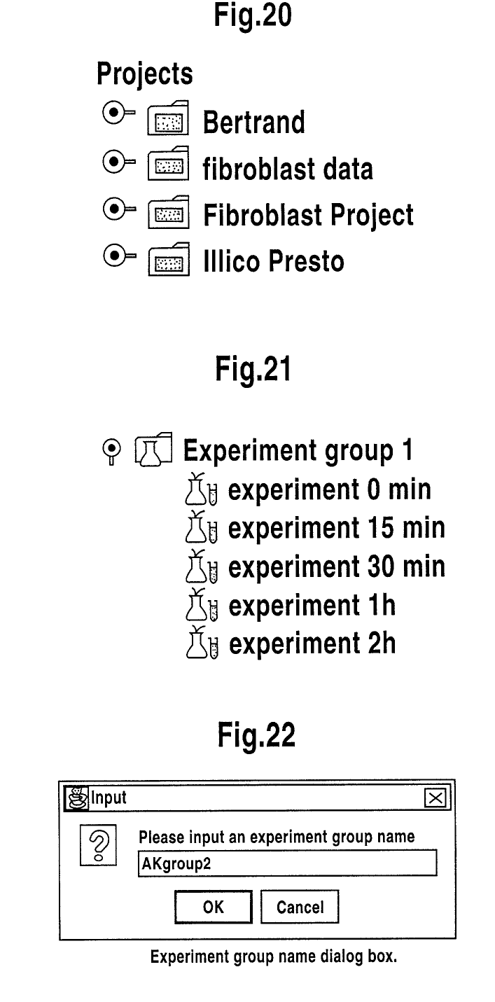

Experiment data saved in the server is accessed by the users through their projects. Within a project, an experiment group folder is created to hold the experiments. The user can then choose which data from the database to import into their experiment group for analysis. Data in the Project List, i.e. experiment groups and gene lists, can be exported to the local machine as ASCII files. An example of a Project Folders display is show in FIG. 20

Projects are folders containing sub-projects as well as experiment groups, gene lists, and user annotations. Data analysis is done within projects. However, before working within a new project, an experiment group should be created in that project and experiments imported into the group. In order to prevent data analysis problems, some embodiments of the invention may require the creation of an experiment group.

Access to your projects may be controlled by granting read only, read/ write, etc. permissions to other users. Access control enables a company to protect the results of experiments in an effort to protect valuable trade secrets.

### Creating a Project

In the Project List, highlight the folder in which the new project is to be created, either the top-level “Projects” folder or one of your own project folders. Choose Edit>New>Project from the menu bar or right-click on the selection and choose New>Project from the menu. A dialog window will open, enter a name for the new project in the text field. Click “OK” and the new project will appear in the project list. The project is automatically saved in the database.

### Deleting a Project From the Project List

Highlight the folder in the Project List. Choose Edit>Delete from the Edit command menu. A “Please confirm” dialog box will open: Click “Yes” to delete the folder. Click “No” to cancel the Delete command.

### Experiment Groups

FIG. 21 illustrates an exemplary experiment group. An experiment group is a set of related experiments collected in one folder for the purpose of analyzing them in relation to each other. For example, a user might have experiments from a culture grown in regular medium, and experiments from a culture starved for carbon. To compare the normal culture against the starved culture, a user would group them, with controls, into an experiment group.

When a user performs analyses, the user first selects an experiment group in the project list, then selects filters to analyze the data. Experiment groups are created and stored inside a project folder, they cannot exist independently in the project list. Their folders may be identified with the image of a flask.

### Creating an Experiment Group Folder

Highlight a project in the Project List and choose Edit>New>Experiment Group from the Edit command menu or right-click on the project and choose New>Experiment Group. A dialog box will open. Enter a name for the experiment group in the text field and click “OK”. An exemplary dialog box is shown in FIG. 22. The new experiment group will be listed in the Project List. The experiment group will be automatically saved in the database.

### Experiments

Experiment groups contain at least two experiments to be complete. Experiments are sets of intensity data from one reading of one chip, micro array or membrane. Typically, all the experiments done to answer a particular hypothesis would be grouped into one experiment group for analysis.

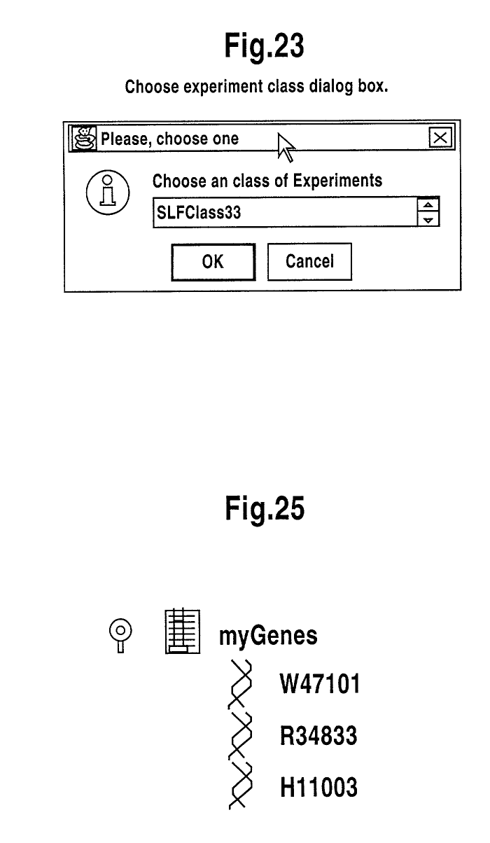

Intensity data is imported by users. In some embodiments a user may require administrator permissions to import data. Upon import into the software database, experiments may be put into classes. An example of a class selection dialog box is shown in FIG. 23. It is possible that the experiments in the class are not all related, some may be using entirely different variables than others.

The order that experiments are added to the experiment group is important. If they are entered in a different order, some of the analysis views may not be so meaningful.

### Add Experiments to Your Experiment Group

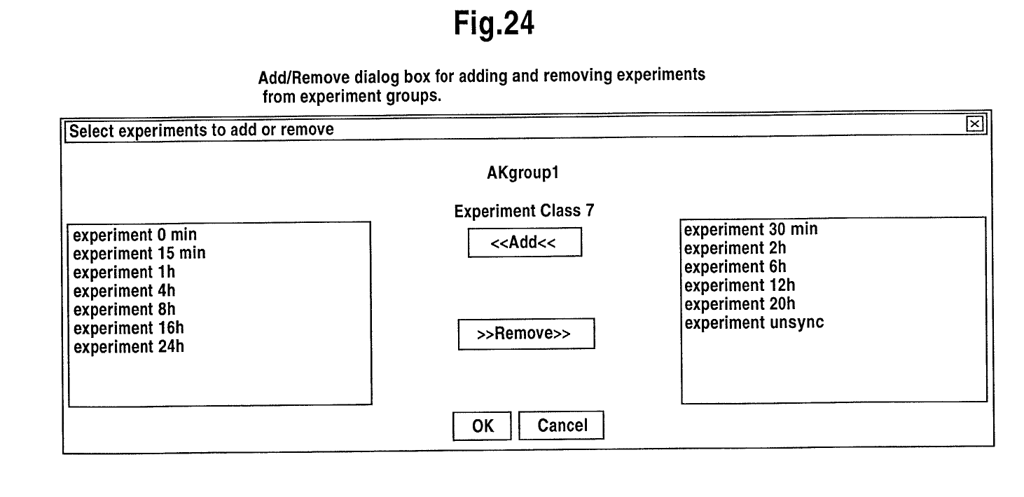

Highlight the experiment group in the Project List and choose Edit>Add/Remove from the Edit command menu or right-click on the experiment group and choose Add/Remove. A dialog box will open, select the class of experiments you wish to choose from. A second dialog box will open listing the experiments in the chosen class. Highlight the experiments in the appropriate order. A user may use the Ctrl and Shift keys to highlight multiple experiments. Click on the “Add” button to move them into the “Add” column. Alternatively, the user can double-click on them and they will automatically shift to the “Add” column. Click “OK” to import the chosen experiments into your experiment group. An sample dialog box is shown in FIG. 24.

### Sublevels of Experiment Groups

A section of experiments may be grouped into a sub group to facilitate analysis on only those experiments. Simply create a new experiment group in the parent experiment group and add to the new experiment group only a subsection of the experiments in the parent group.

### Gene Lists

Once the experiment group is analyzed, there will probably be a selected group of genes for further study. Unwanted data can be screen out and analysis performed on just these genes by first creating a gene list. A sample gene list is shown in FIG. 25. Gene lists can be annotated, exported and analyzed in the same manner that experiment groups are analyzed, generating a clearer view of the specific genes of interest.

### Creating a Gene List

Gene lists are stored in your project folder. Gene lists are displayed in the Project List as lists with an overlying chromosome. The genes inside the gene list are depicted as a DNA helix. Select genes of interest in the analysis views. Highlight the project folder in which you want to save the new gene list. Choose Genes>Save Selection As Gene List from the Genes command menu. A dialog box will open asking you to confirm that you wish to save the list of selected genes as a new gene list. Click on the “Yes” button. A second dialog box will open asking you to enter a name for the new gene list. Type in the name and click “OK”. The new gene list will be saved in the highlighted project folder.

### Annotating

Over time a user will probably have many projects, experiment groups, experiments and gene lists in the Project List. To remember details of each, i.e. experimental conditions, interesting observations on the behavior of particular genes, etc. it is helpful to annotate them with comments about them and an analysis of them.

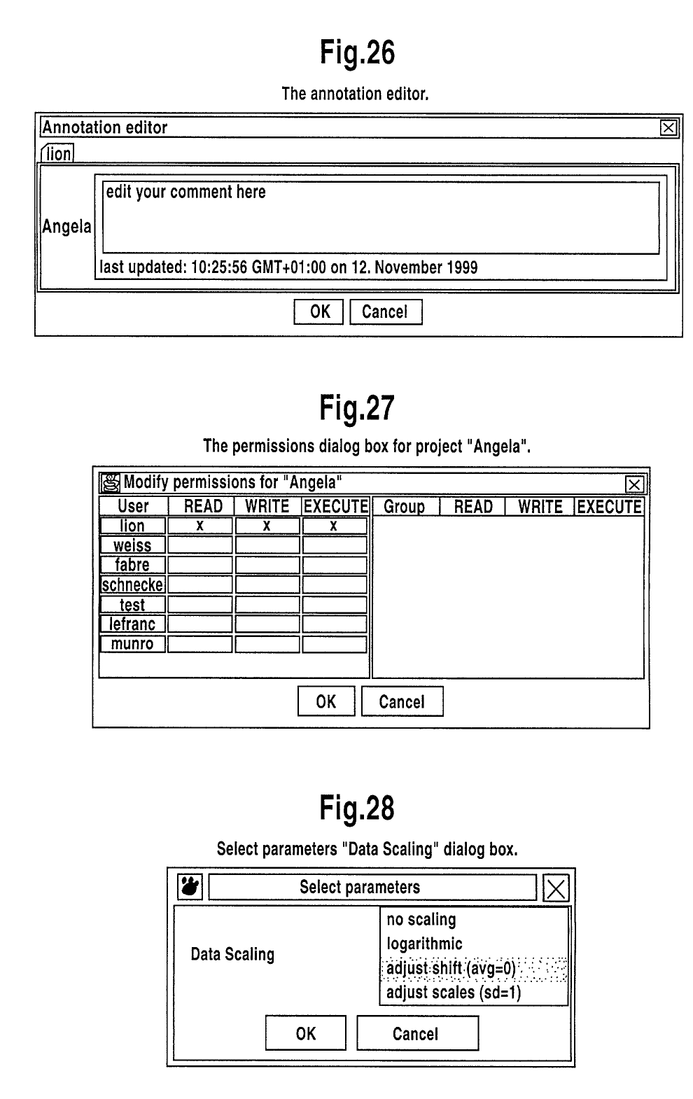

Annotations are written and read in the annotation editor. A sample editor is illustrated in FIG. 26. When the annotation editor for a Project List item is opened (project, experiment group, etc.) a tab with the users name may appear. The tab has a text box which will say “edit your comment here” upon opening it for the first time. To the left of the text box is the name of the Project List item you are annotating. Below the text box is the date and time of the last update of this annotation.

In the text box, write in the comment. Clicking on “OK” will save the comment. Clicking on “Cancel” will close the annotation editor without saving the comment or changes. The “last updated” date and time for the annotation is the taken from the client computer when the user clicks “OK”.

The next time the user opens the annotation editor for this Project List item, the user will open the tab and be able to read and edit the previous comments. Other users who open the annotation editor for the same Project List item will get their own tab for adding their annotations. Users can read other users' annotations, but can only edit their own.

### Saving Annotations

Click on a Project List item to highlight it. Choose Edit>Annotate from the Edit command menu, or right-click on the item and choose Annotate, the annotation editor window opens. Erase the text, “edit your comment here” and type your annotation in the text field. Click “OK” to save your annotation and close the editor window.

### Viewing Annotations

Select the Project List item whose annotations a user desires to view. Choose Edit>Annotate from the Edit command menu, or right-click on the item and choose Annotate, the annotation editor window opens. Click on the tab for the annotation to read. A user can edit only their own annotation, simply by typing in the text field. Click “OK” to close the Annotation Editor and save any changes.

### Permissions

A user can set the permissions for their projects and experiment groups controlling who has read, write and execute access to them. Permissions can be given to individual users and /or to user groups. Permissions are modified in the permissions dialog window, an example of which is shown FIG. 27. The window contains two tables: the left-hand table is for user permissions and the right-hand table is for group permissions. The tables have rows for each user or group and columns for each access type: read, write and execute.

To set the permissions for your project: Highlight the project or experiment group in the Project List. Choose Edit>Permissions from the Edit command menu. The permissions dialog window will appear. Click in the “Read” “Write” or “Execute” column next to a user's name, this places an “X” in that box, and grants those permissions. Click “OK” to save the new permissions and close the dialog box.

### Exporting

Using the export option, you can export your experiment groups and gene lists to your local machine as RDB format files (tab delimited text). You have the options of simply exporting the gene names or you can include their descriptions and intensity values as well. When exporting gene lists you must select the experiment group from which the intensities will be read. Exported files can be opened with Microsoft Excel™, Word™ or any simple text program.

### Exporting Experiment Groups

Highlight your experiment group in the Project List window. Select File>Export from the command menu. A dialog box for selecting the destination of the exported file will open. Choose the location in which you want to store the experiment group, click “EXPORT”.

### Exporting Gene Lists

Highlight your gene list in the Project List window. Select File>Export from the command menu. A dialog box for selecting the experiment group to associate the genes with will open. Select the experiment group to get the intensities from. Click “OK”. A dialog box for selecting the destination of the exported file will open. Choose the location in which you want to store the experiment group, click “Export”.

### Analysis Filters

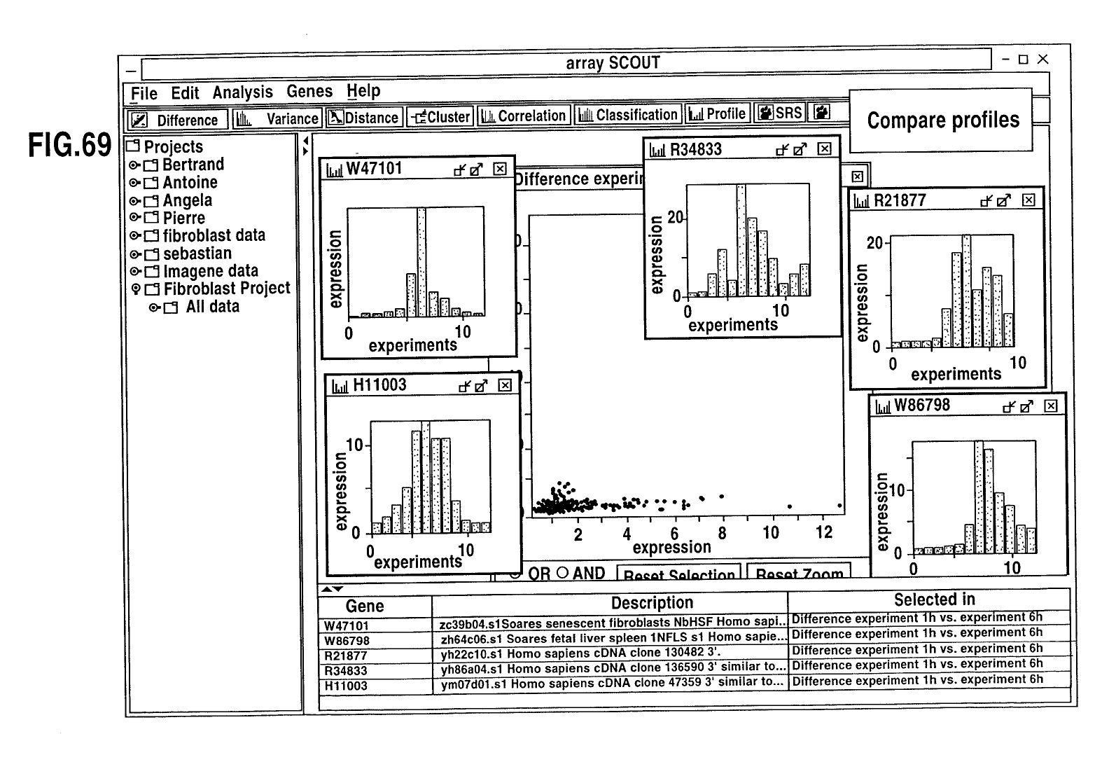

The software provides many algorithms for analyzing data. A user can plot two experiments against each other in the difference plot. Clustering can be done by their principle components with the distance plot, or with the cluster tree. You can create histograms displaying the variance of expression levels across an experiment group, gene classifications and genes that adhere to a preconceived profile. With the gene profile, a user can visualize the expression pattern of a single gene across many experiments. The user can select genes that look interesting in any plot or histogram, and they will be automatically selected in all open analysis views for easy comparison of analyses (FIG. 69). These plots are explained below in greater detail.

The different analysis filters will extract different information from the experiments. Using multiple filters in combination with the cross-window selection capabilities allows the user to quickly gain valuable insight into the experimental data. Experiments are analyzed in the context of an experiment group. The experiment group, for example, may be a series of time points or comparable experiments from a wild type and a mutant. The experiment group is typically highlighted in the Project List window before selecting an analysis filter.

Each analysis opens in its own window within the analysis window. As discussed above, the individual analysis windows can be resized, minimized and maximized. When there are many analysis windows open, they will overlap making it difficult to see them all. The “Windows” command menu will list all of the analysis windows open; highlighting a window will cause it to move to the front.

When starting a new analysis filter, the user may be asked to select parameters. The data scaling procedure is the only parameter which is used by all the analysis filters (except the gene profile), so it will be explained first.

### Data Scaling

Scaling of the data allows the user to adjust the units of the plot and histogram axes or the position of the data in the plots. When you start a new analysis, a dialog window will pop open asking you to select the scaling procedure. A sample of this dialog box is illustrated in FIG. 28. The scaling procedure suggested as best suited to a particular analysis filter will be automatically highlighted. The user can choose a different scaling procedure, or no scaling of the data, by highlighting the desired option in the menu. The choices are:

1) no scaling—the data values are used as is; 2) logarithmic—this plots the exponent of the value, instead of the actual value, e.g. 10 is plotted as 1, 100 as 2 and 1000 as 3, etc. creating a plot with a much smaller scale; 3) adjust scales (sd=1)—this creates a plot in which the standard deviation is equal to one, no matter the shape of the curve, thus, curves created from data having very different ranges of values can be compared; 4) adjust shift (avg=0)—this centers the data in the plot; 5) Correlation Histogram—the Correlation Histogram has a specific set of procedures to normalize the target values that you enter; 6) no scaling—values are used as is; 7) logarithmic range—interprets your values as log values; and 8) unit range—sets the highest value you enter equal to 1 and the lowest value equal to −1, all intermediate values are adjusted accordingly. If the data includes negative values, do not choose the logarithmic procedure.

### Difference Plot

The difference plot lets you plot one experiment against another. Genes whose expression varies between the two experiments will fall farther from the 45 degree diagonal, where expression in both experiments is the same (x=y), than those whose expression levels are similar in the two experiments.

### Starting a Difference Plot Analysis

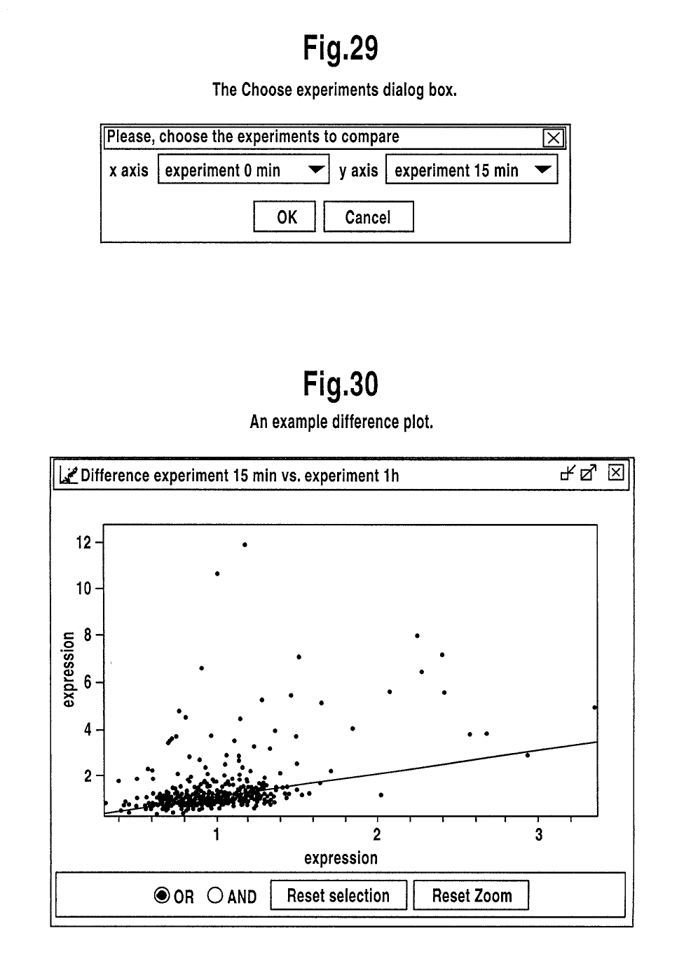

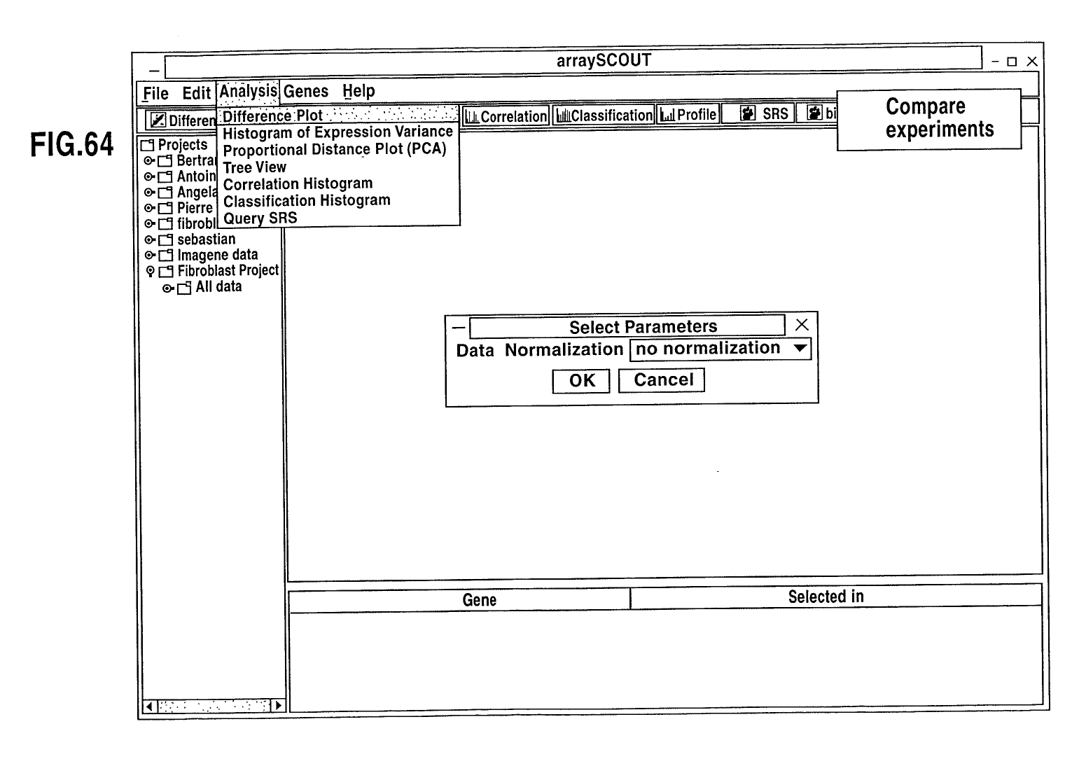

Within a project, highlight the experiment group to analyze. Click the Difference button in the tool bar or choose Analysis>Difference Plot from the Analysis command menu. A dialog box will open asking you to choose a scaling procedure. A sample dialog box is illustrated in FIG. 64. Make a selection from the menu and click “OK”. A second dialog box will open, select the experiments to plot on the x and y axis, click “OK”. An exemplary dialog box employed to select experiments is shown in FIG. 29.

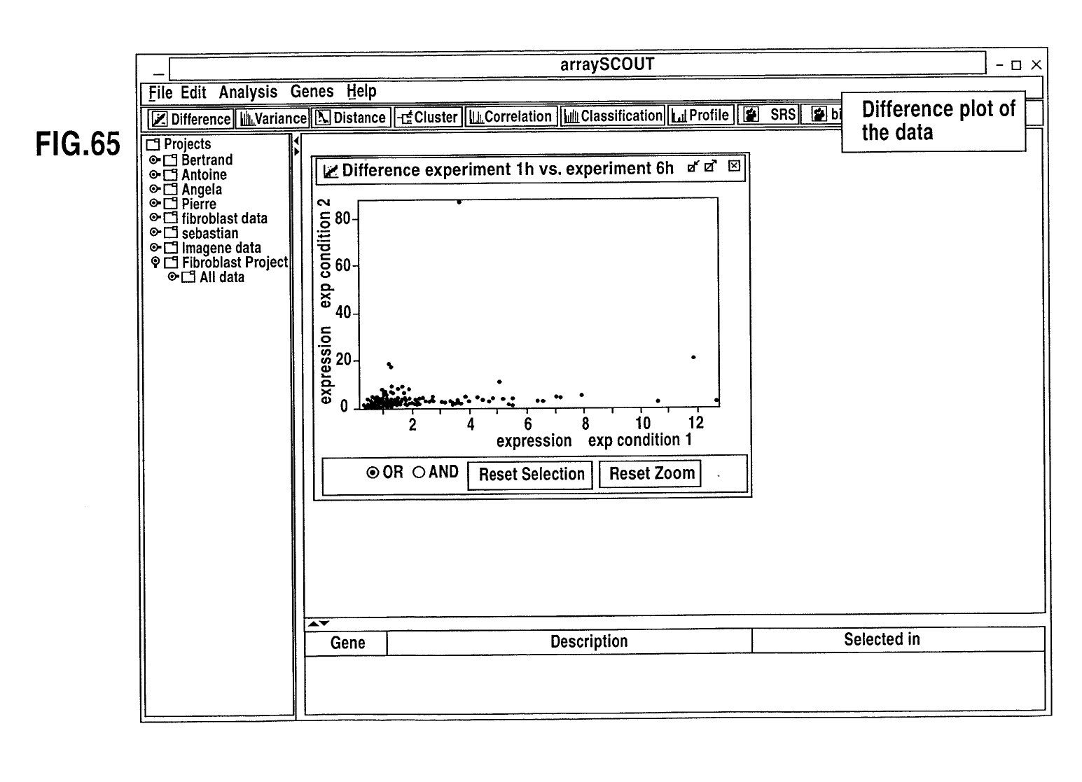

Only 2 experiments out of the experiment group can be compared in the difference plot. To compare all the experiments, use the distance plot. Sample difference plots are illustrated in FIGS. 30 and 65.

### Interpreting the Difference Plot

The difference plot displays the genes in the experiment group as dots. The position of the dot is determined by the expression levels measured in the two experiments selected in the dialog box (FIG. 29). The expression level in the first experiment selected determines the x- coordinate and the expression level in the second experiment determines the y- coordinate. So, a gene at position (1,4) is expressed, in the second experiment, four times as much as in the first experiment.

The diagonal line on the plot can be used to distinguish genes by their degree of difference in expression between the two experiments. From this line you can create a cone, which excludes genes which have x-fold over/under expression less than a cutoff. To create this cone, position the mouse over the diagonal line to get the plus-sign cursor (+). Click and drag this cursor over the plot, away from the diagonal. This will open an information bubble displaying a number times expression, e.g. “3×Expression”. From this cutoff genes having a higher level of expression difference are excluded by the cone drawn when the left-mouse button is released. If genes were selected (highlighted) prior to drawing the cone, releasing the left mouse button will deselect genes falling inside the cone.

The name of a gene may be revealed by holding the mouse over the plot, the gene name will appear in an text bubble. To make the selection text bubble (“3×Expression”) disappear, click on it. To reset the cone, simply position the mouse over the diagonal line to get the plus-sign cursor and click with the left mouse button.

To zoom into the analysis view, click and drag with the right mouse button around the area you would like to zoom into. Click the “Reset Zoom” button to reset the view.

In the Difference Plot and the Distance Plot the numbers along the axes refer to the relative expression levels of the plotted genes. A gene plotted at (4, 20) in the Distance Plot is expressed a relative level of 4 in the experiment plotted along the x-axis and is expressed a relative level of 20 in the experiment plotted along the y-axis. Units are arbitrary.

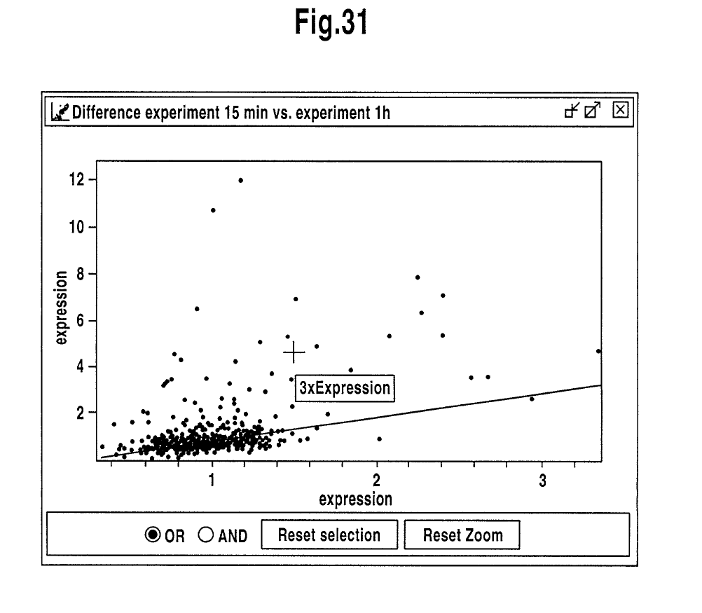

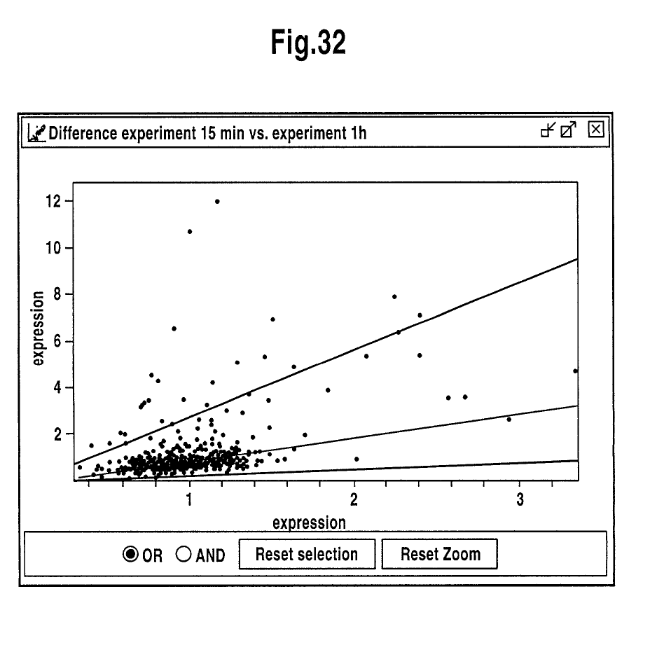

FIG. 31 illustrates a difference plot with cursor and text bubble. FIG. 32 shows a difference plot with genes having a 3-fold difference in expression levels between the two plotted experiments (3×Expression) excluded by the cone.

### Distance Plot

The distance plot is a variation of principle component analysis (PCA). It plots the genes in the selected experiments in such a way that the distance between genes on the plot is directly proportional to the difference in expression levels of those genes. To create the plot, you must select a scaling procedure and two axes which represent the degree of variation in your data (the principle component).

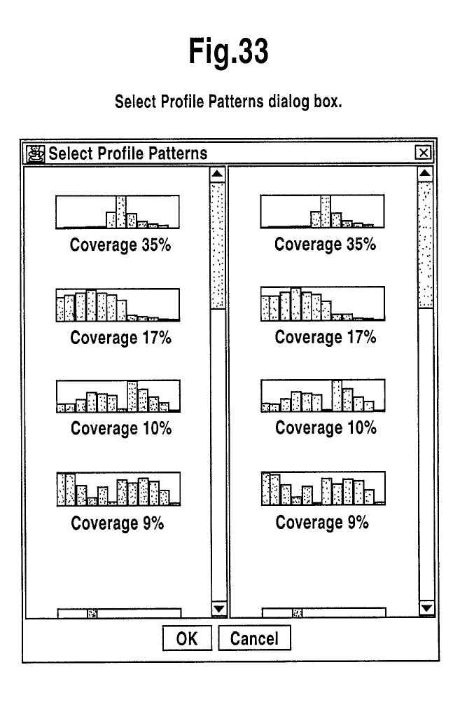

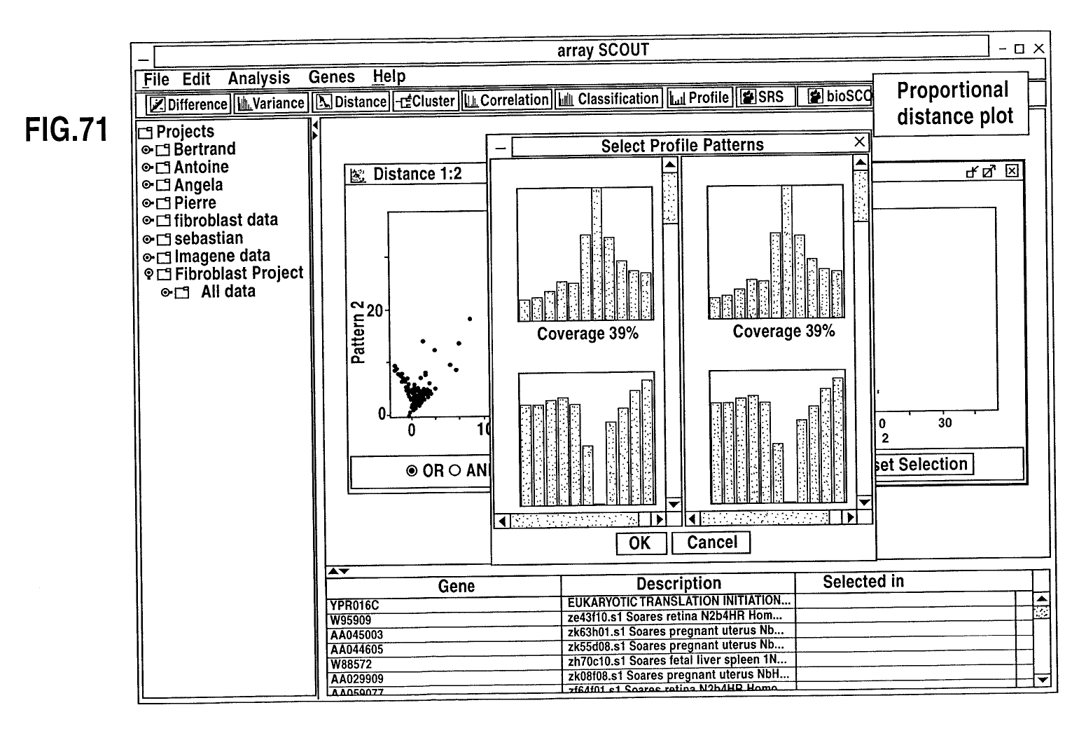

When you create a new distance plot, a dialog box will opens to select a scaling procedure (an example is illustrated in FIG. 28). When the user clicks “OK”, a second dialog box will open displaying representative expression patterns as histograms. Examples of this dialog box are provided in FIGS. 33 and 71. Patterns shown in FIG. 33 are those particular to an example data set, other data sets may display different patterns. The patterns selected define the x and y axis of the plot, determining the plane viewed. The coverage numbers below the patterns show how much information is represented in that pattern. The two patterns that cover the greatest percentage of variance in the experiments are automatically selected. The user can select different patterns to represent the x and y axis, giving a different view of the data, by clicking on alternative histograms.

The position of a gene in this plot gives the relative degree of similarity between its expression and the expression of all the other genes and between the gene's profile and the chosen axis patterns. The closer a gene lies to another gene, the more similar their expression profiles, and the closer the gene is to an axis, the more its profile resembles that of the chosen axis pattern. Outliers show non-average expression profiles and variance coverage.

### Starting a Distance Plot Analysis

Within a project, highlight the experiment group to analyze. Click on the “Distance” button in the tool bar or select Analysis>Distance Plot from the Analysis command menu. A dialog box will open, choose a scaling procedure, click “OK”. A sample scaling dialog box is illustrated in FIG. 28. Select two patterns to cluster on, click “OK”. The analysis will open with the numbers of the two experiments chosen listed in the frame of the plot.

### Interpreting the Distance Plot

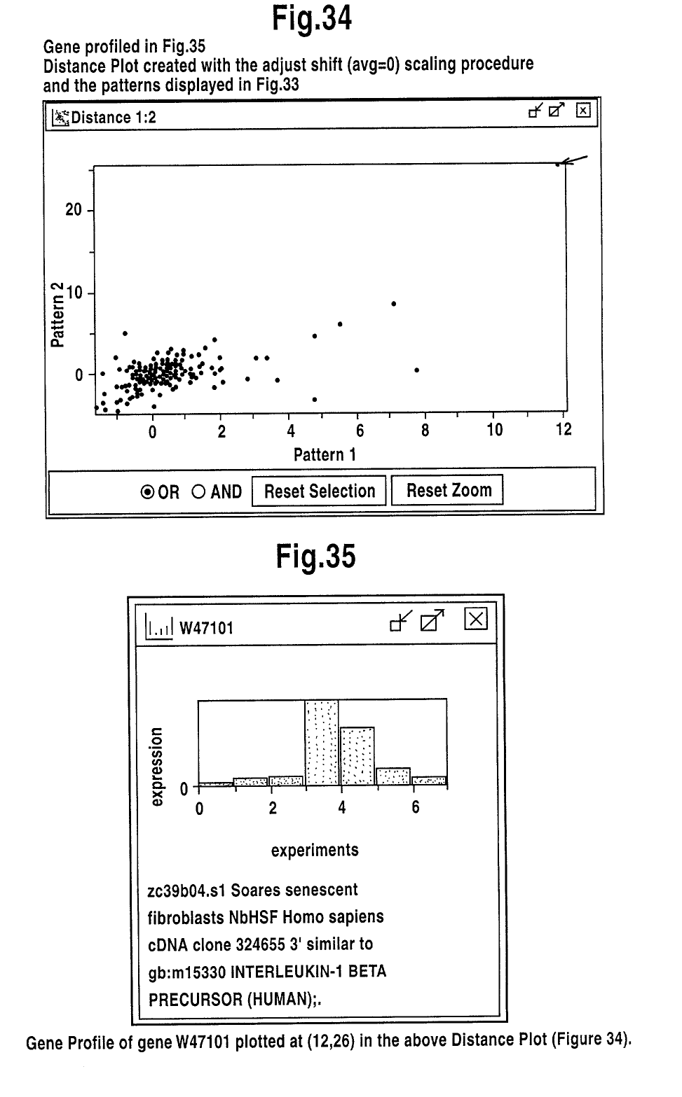

Most of the genes in the above distance plot are very close together forming a tight cluster; this is typical. The genes in the cluster all have similar levels of expression across the course of the experiments in the group and hence similar expression profiles. They represent the average. A sample distance plot is shown in FIG. 34. In this example the, scales on the x and y axes are different. This is done to center the data. The numbers on the x-axis are smaller, meaning that the genes are actually plotted closer to this axis than to the y- axis. This is because these axes represent the patterns chosen in the dialog box on which the data is clustered, and if you recall, the pattern automatically selected for the x-axis represents the expression profile covering the highest percentage of variance and the pattern for the y-axis the second highest percentage. Thus, most of the genes will be plotted closer to the x-axis than to the y-axis.

The genes which fall at a distance from this cluster, mostly to the right, display very different expression levels from the average gene. If the gene falls at a coordinate which is high on both the x- and y- axes that gene also has an expression profile which is very different from the average. You can reveal the name of a gene by holding the mouse over the plot, the gene name will appear in a text bubble. To zoom into the analysis view, click and drag with the right mouse button around the area you would like to zoom into. Click the “Reset Zoom” button to reset the view.

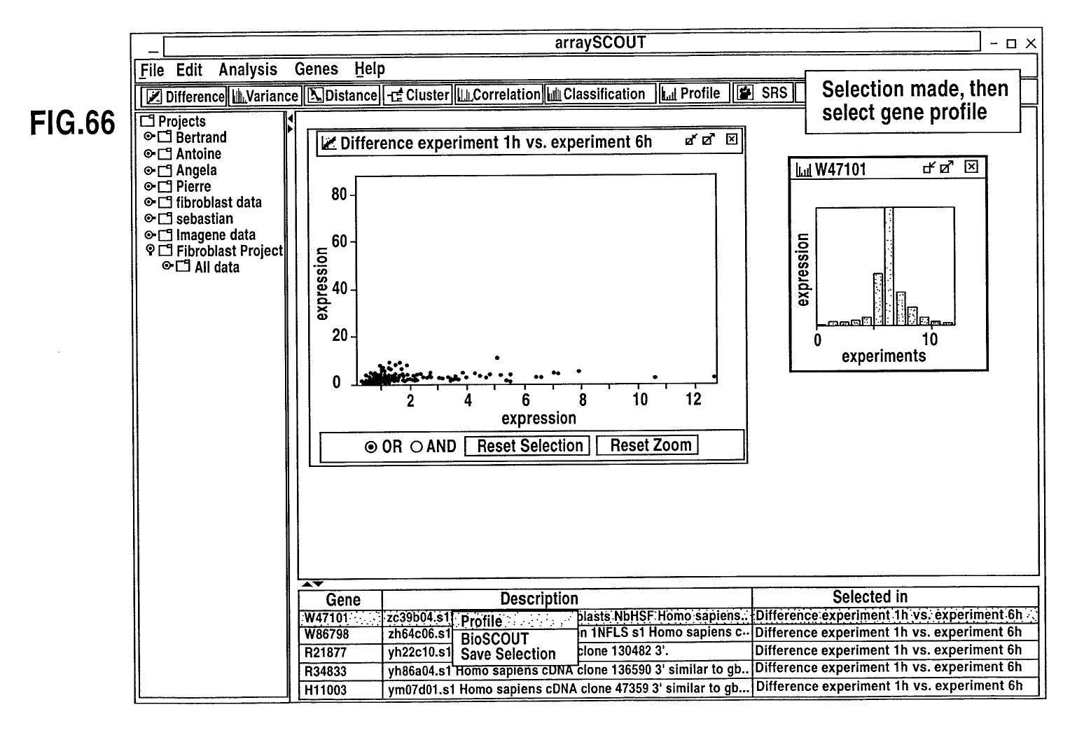

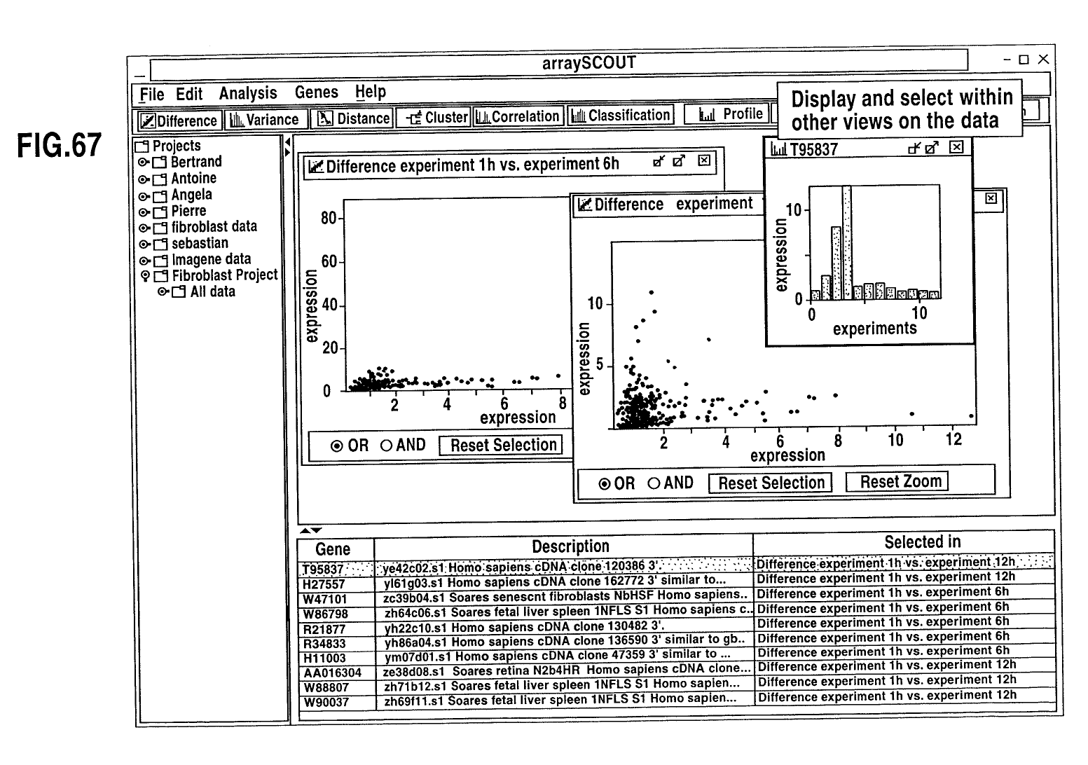

If we select the gene plotted at (12,26) in FIG. 34 (designated by the arrow) it is added to the Gene List window. We can highlight it in the Gene List window and create a Gene Profile. Exemplary gene profiles are shown in FIGS. 35 and 66. Looking at the profile we can see how it differs from those used to define the x- and y-axis of the Distance Plot. Additional information about selected genes may be obtained by linking them to SRS or similar software as discussed in detail below.

### Variance Histogram

The variance histogram depicts the standard deviation of expression levels across a series of experiments vs. the number of genes that display such a level of variance in expression level. The genes having little variation in expression levels over the series of experiments will be found together at the left end of the histogram. The genes that do show inconsistency in expression levels across the series of experiments will be found to the right of the histogram. To determine the exact coordinates of the top of a histogram bar, in any histogram analysis, mouse over the bar and the coordinates will be displayed.

### Starting a Variance Histogram Analysis

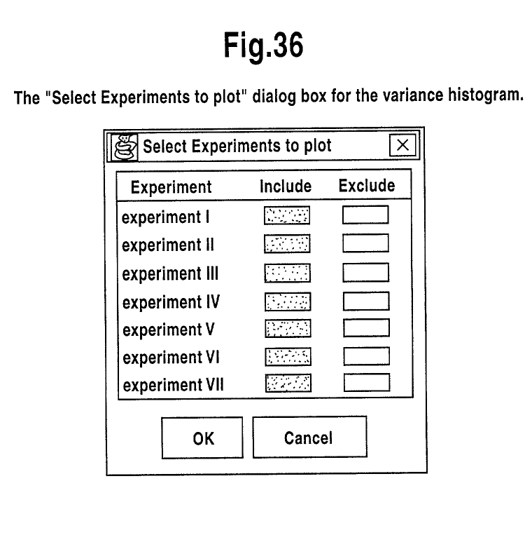

Select the experiment group you wish to analyze by highlighting it in the project list. Alternatively, the user may click on the analysis in the tool bar or select Analysis>Variance from the Analysis command menu. A dialog box will open. Click in the exclude column to shade the box for each experiment you wish not to be used to calculate the histogram. When happy with the selection of experiments to include in the histogram, click “OK. FIG. 36 provides an exemplary dialog box that may be employed to select the experiments, if any, to exclude from the analysis.

### Interpreting the Variance Histogram

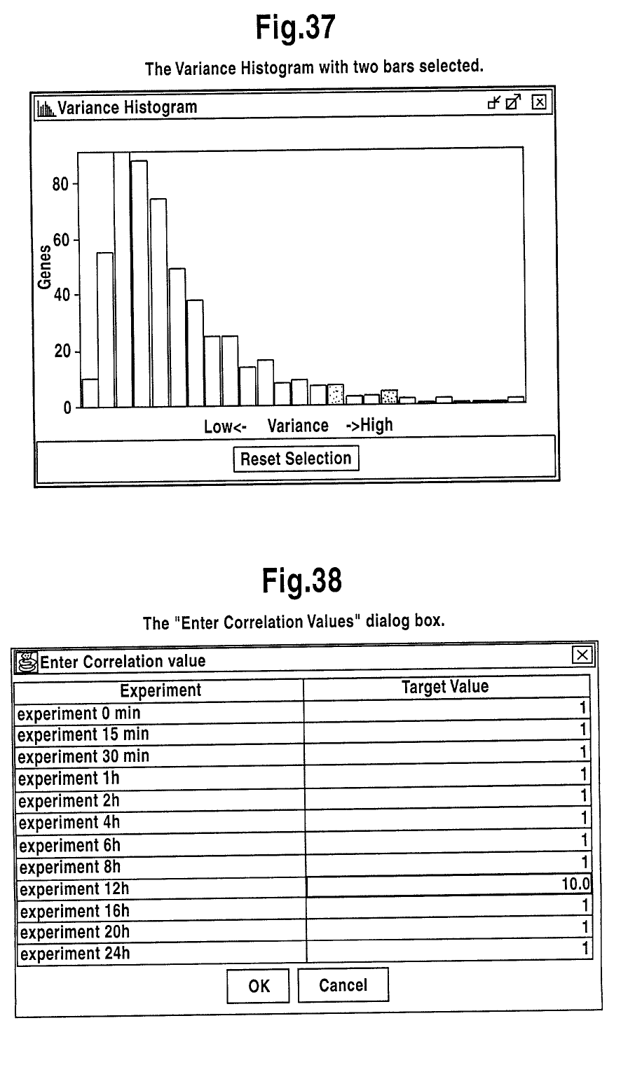

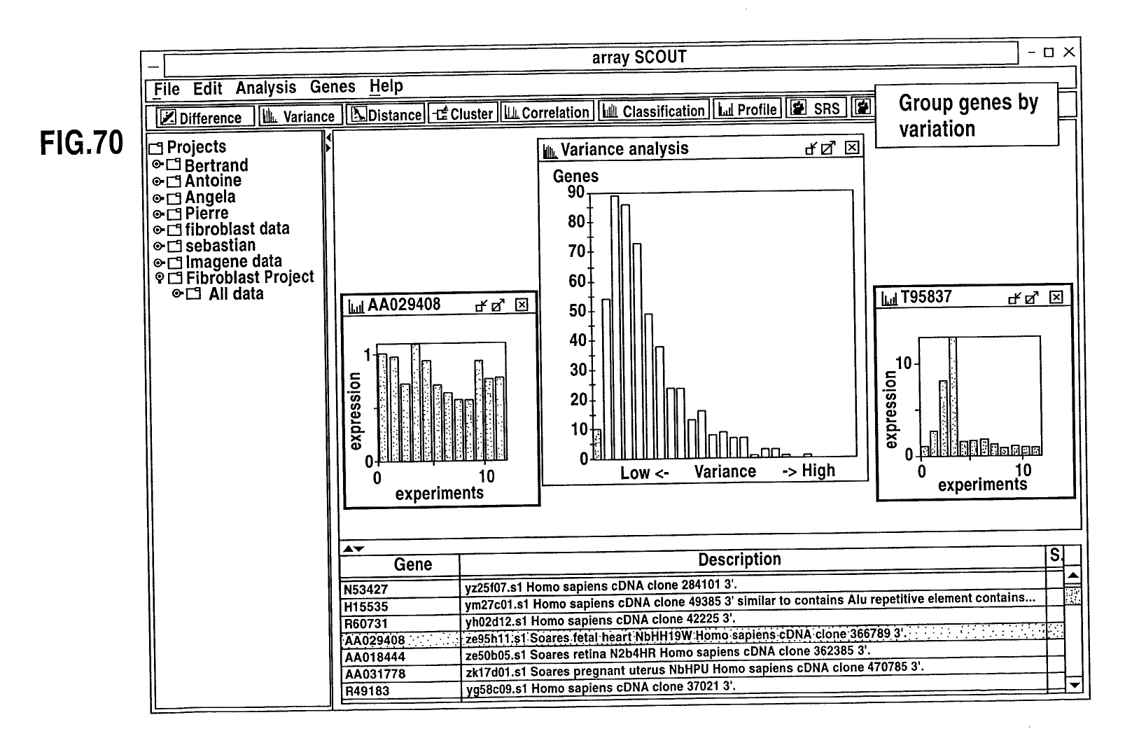

Typical variance histograms are illustrated in FIGS. 37 and 70. The x-axis displays the relative amount of variation in expression levels across the experiments included in the histogram going in the left-to-right direction from low to high. The y-axis displays the number of genes showing a particular level of variance, i.e. the number of genes in each bar.

In this example, most of the genes are found toward the left, at the low end of the histogram, meaning that they have steady expression levels over all the experiments in the group. Their expression levels can be low or high as long as they remain constant.

The tail of the histogram, toward the high end, displays the genes which show, from left to right, medium to high degrees of fluctuation in expression level over the course of the experiments. These are the genes that are up or down regulated at some point in the experiment.

The histogram typically, does not display any information about the type of variation displayed by the genes. In other words, the user cannot see from this analysis if the genes, which show some variance, are up or down regulated. However, the user can get this information by: first, clicking on the histogram bars of interest, the selected genes will be listed in the gene list window; and second, creating a gene profile of these gene(s).

### Correlation Histogram

The correlation histogram allows a user to enter a pre-conceived set of values defining a search vector, for example a gene expression profile, and plot the genes in the experiment group according to how their expression behavior correlates to your target values.

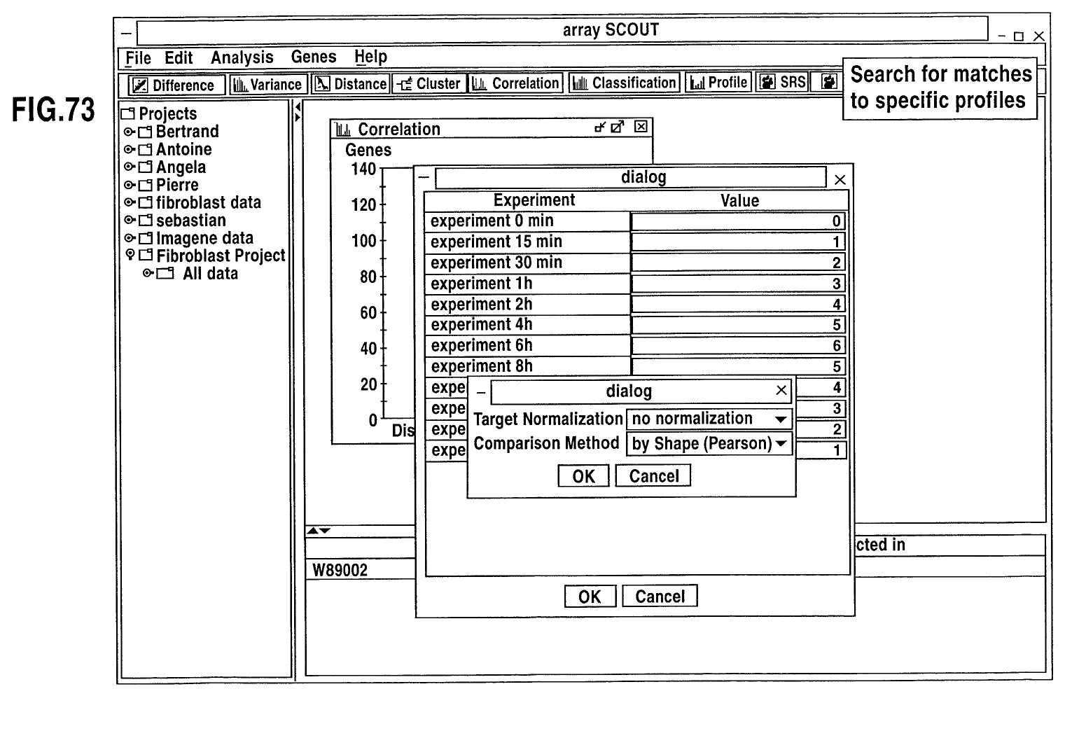

There are two ways correlation can be sought: one, by comparing the shape of the profile (vector) given by your target values or two, by comparing the absolute values. You must specify which comparison method to use in the “Select Parameters” dialog box. Samples of this dialog box are illustrated in FIGS. 38 and 73.

### Starting a Correlation Histogram Analysis

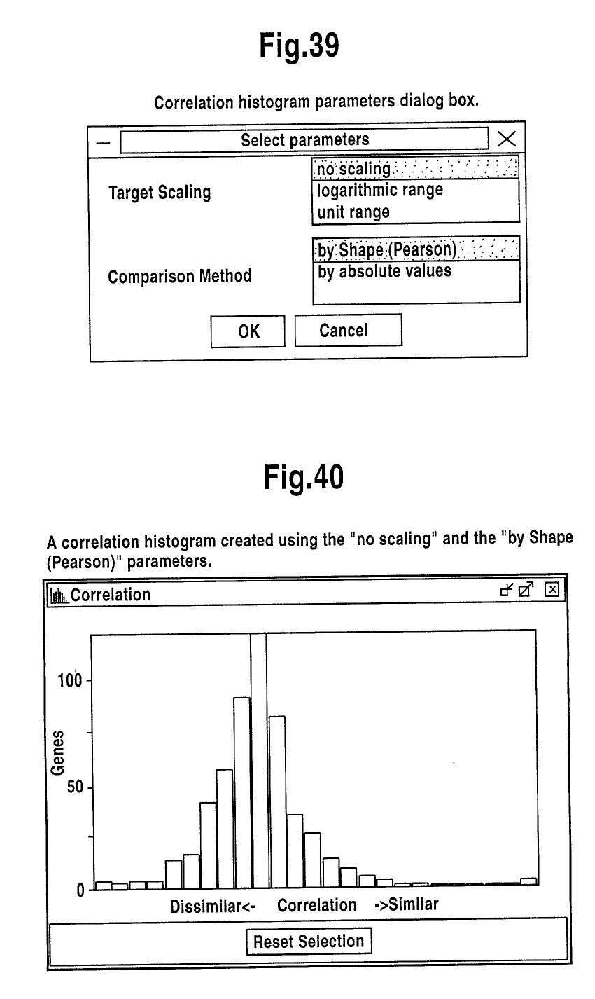

Select the experiment group you wish to analyze by highlighting it in the project list. Click on the “Correlation” button in the tool bar or select Analysis>Correlation Histogram from the Analysis command menu. A dialog window will open. Select a scaling procedure and a comparison method from the menus. Click “OK”. An example of a dialog box where a user may select both the scaling procedure and comparison is illustrated in FIG. 39. A second dialog window for entering expression values for each of the experiments will open. Click in the “Value” column to edit the expression value for each experiment in the group. (You must click 3 times, once to highlight the value you wish to change, then a double click to get the cursor.)

Alternatively, if you have a Gene Profile open, you can select that profile and import the values directly from it. Hit the “Enter” key after editing the last value in the list to enter that change before clicking “OK”. Click “OK”.

### Interpreting the Correlation Histogram

The correlation histogram illustrated in FIG. 40 was created with the example data shown in the “Enter Correlation Data” dialog box (FIG. 38) using the “no scaling” and “by Shape (Pearson)” parameters (FIGS. 39 and 73). The x-axis, from left to right, displays the relative degree of similarity between the expression profiles of the genes in the experiment group and the target values you input. The y-axis displays the number of genes which fall into each bar of the histogram.

In the example shown in FIG. 40, the experiment group consisted of a series of time points ranging from time zero to time twenty-four hours. Because the Pearson option was selected, the target profile, to which all the genes are compared, experiences a ten-fold increase in expression at time twelve hours, regardless of the starting level of expression. If the “absolute values” parameter had been selected, the target would have identified genes having a constant level of one and an increase to ten at time twelve hours.

Looking at the histogram, most of the genes fall on the left side of the histogram, indicating that their expression profiles do not match the target value input. There are several short bars creating the right-hand tail of the curve. These genes have expression profiles which are increasingly similar to the target values entered in the dialog box and there is a single bar, far to the right, which is apparently very similar to the target value. Selecting this bar, by clicking on it reveals that it represents a single gene. Creating a gene profile permits a comparison of the displayed gene's profile to the target values entered.

### Classification Histogram

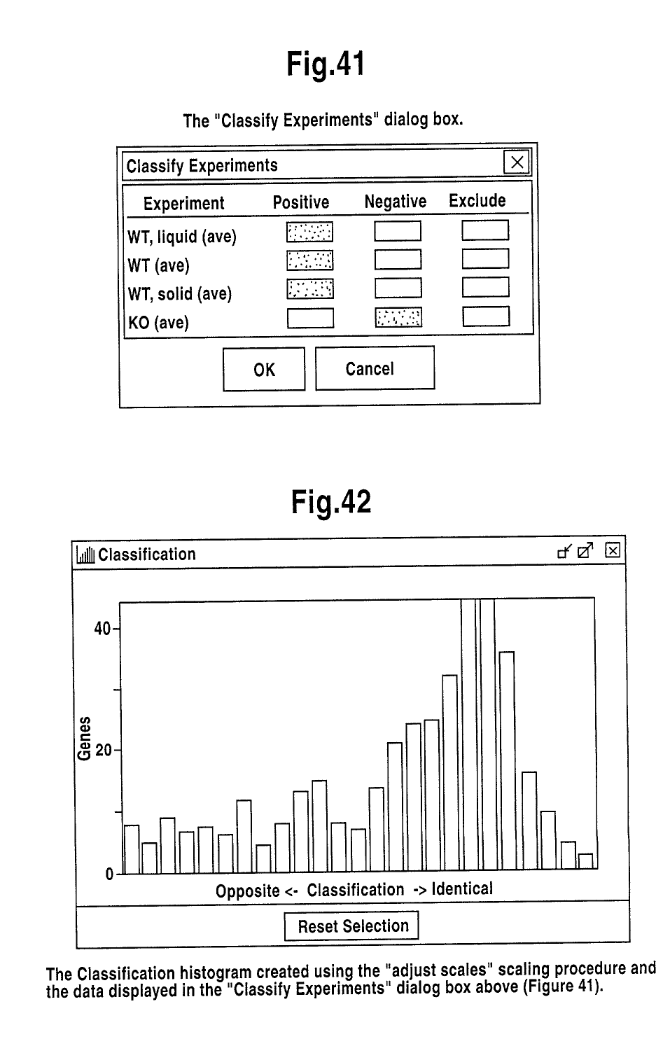

This analysis filter allows the user to classify experiments and look for genes that can be classified the same way. A sample Classify Experiments dialog box is illustrated in FIG. 41. For example, in the experiment group, there may be some experiments from a wild type cell and some from a mutant cell. Thus, these experiments can be segregated into two classes. Consequently, genes whose up/down regulation can be segregated along the same lines.

The histogram is created by plotting the degree of correlation between the gene expression profiles and the experiment classes versus the number of genes showing such a degree of correlation. Genes that are highly expressed throughout the experiments in the positive class and expressed at low levels in the negative class are positively correlated to your classes. If they are expressed at low levels in the positive class of experiments and highly expressed in the negative class, they are negatively correlated. If the genes do not show a consistent expression level within a class, or the expression levels are the same in both classes, than there is no correlation between gene expression and the classes and these genes cannot be classified. These relationships are illustrated in Table VI below.

TABLE VI
Comparison of expression levels in classified experiments.

| | | gene 1 | gene 2 | gene 3 |
|---|---|---|---|---|
| Experiment | | expression | expression | expression |
| Class | Experiment | level | level | level |
| Positive | exp. 1 | high | Low | low |
| | exp. 2 | high | Low | high |
| Negative | exp. 3 | low | High | low |
| | exp.4 | low | High | high |
| | exp. 5 | low | High | low |

| | | | |
|---|---|---|---|
| Gene expression shows | yes, positive | yes, negative | none - center |
| correlation to exp. class? | correlation - | correlation - | of histogram |
| | identical | opposite | |
| | tail of | (or inverse) | |
| | histogram | tail of | |
| | | histogram | |

### Starting a Classification Histogram Analysis

Select the experiment group you wish to analyze by highlighting it in the project list. Click on the “Classification” button in the tool bar or select Analysis>Classification Histogram from the Analysis command menu. A dialog window for classifying the experiments will open. A sample of this dialog box is shown in FIG. 41. All experiments are initially marked as “Positive”. Click in the “Negative” or “Exclude” column to move the “X” for each experiment into that class. Moving an experiment into the exclude class will cause it to not be used in the calculation of the histogram. Click “OK”.

### Interpreting the Classification Histogram

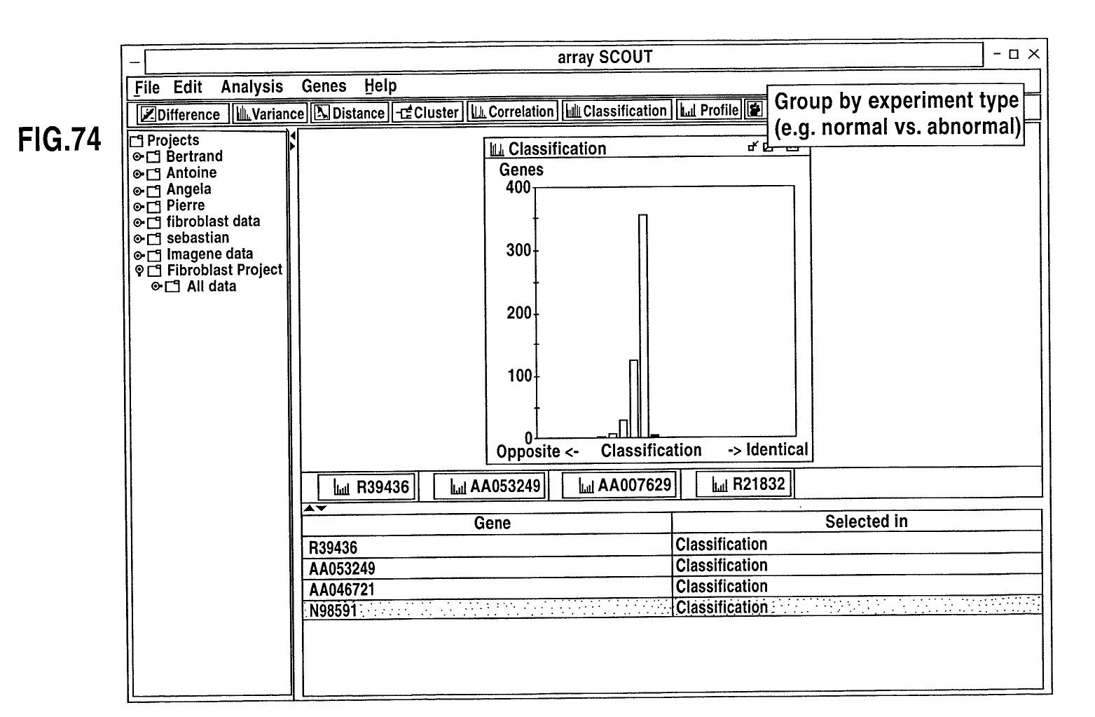

The classification histogram shown in FIG. 42 was created using a set of 4 experiments. A second classification histogram is shown in FIG. 74. Three of the experiments shown in FIG. 42 were wild type and one was a knockout. The wild type experiments were classified as positive and the knockout experiment was classified as negative (FIG. 41). From left to right, the x-axis displays the range of classes, opposite to identical, in which the genes fall according to the correlation found between the gene's expression profile and the experiment classes defined in the “Classify Experiments” dialog box (FIG. 41). Typically, gene expression profiles and experiment classes are compared by shape, not by absolute values. The y-axis displays the number of genes which fall into each bar/class of the histogram.

The genes lying on the far left of the histogram shown in FIG. 42, at the “Opposite” end, are the genes which are negatively correlated to the experiment classes. These genes exhibit a low expression level in the wild type experiments and a high expression level in the knockout experiment, possibly up-regulated in response to the knockout.

The genes falling in the middle of the histogram shown in FIG. 42 cannot be classified. These genes do not show a change in expression level that is particular to one or the other experiment classes. It is likely that they have not been affected by the knockout.

The genes falling to the far right of the histogram shown in FIG. 42, on the “Identical” end, are those which are positively correlated to the experiment classes. These genes show a high expression level in the wild type experiments and a low expression level in the knockout experiment. Perhaps these genes have been down-regulated as a consequence of the knockout.

### Cluster Tree Analysis

The cluster tree analysis hierarchically clusters genes by similarity in their expression profiles, creating a tree view of all the genes in the experiment group and their relationships to each other. Next to the tree view is a colored bar for each gene showing its relative expression level in each experiment. You must select the reference state from which the up/down regulation will be measured. You can select a particular experiment or you can select to use the mean value of all experiments as the reference state.

### Starting a Cluster Tree Analysis

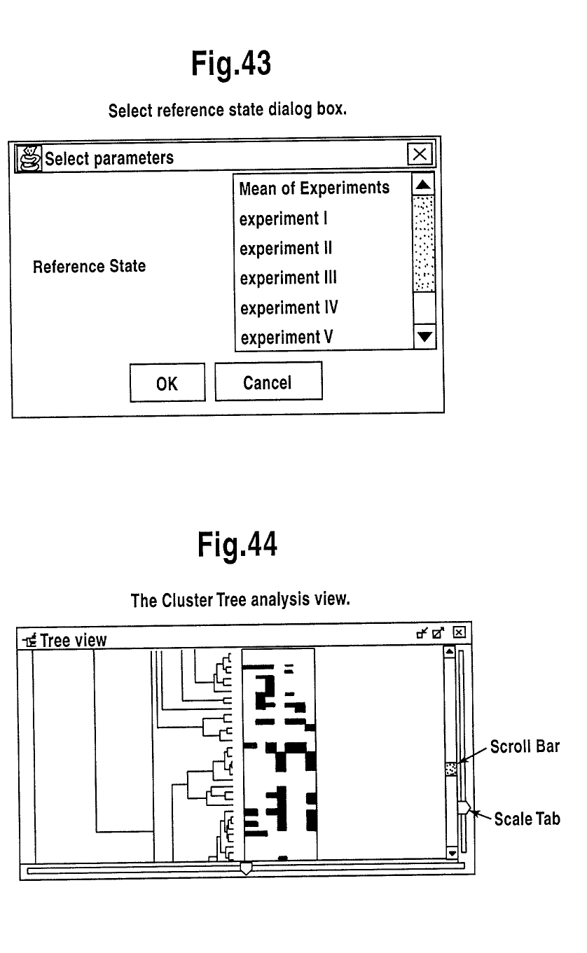

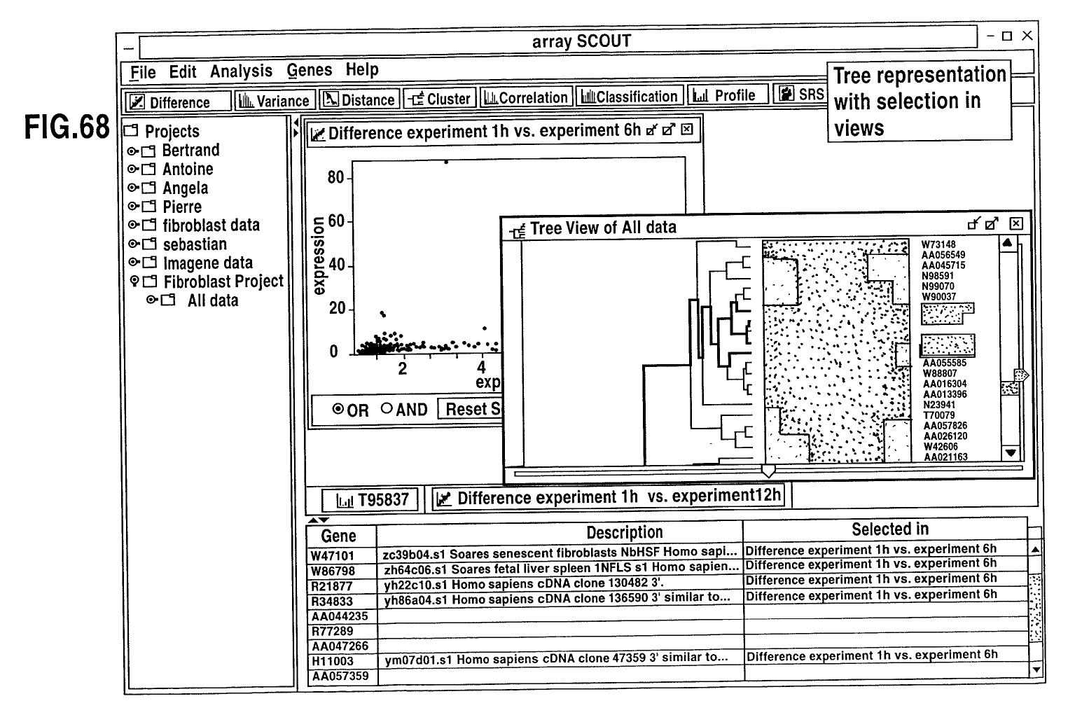

Within a project, highlight the experiment group you wish to analyze. Click on the “Tree-plot” button in the tool bar or select Analysis>Tree View from the Analysis command menu. A dialog box opens listing the experiments in the experiment group. Choose an experiment or choose “Mean of Experiments” as the reference state by clicking in the menu. A sample dialog box that may be employed to choose the reference state is shown in FIG. 43. Click “OK”. Exemplary cluster trees are illustrated in FIGS. 44 and 68. This cluster tree was obtained by using the sample dated discussed above.

### Interpreting the Tree View

The Tree View can be adjusted by sliding the scale tabs and sliding the scroll bars. Scaling back to see a greater area may help the user see the clusters and determine which part of the tree looks interesting. Zooming in on an area will allow the user to see details of the tree and the genes represented in those leaves.

Branch lengths in the tree diagram are proportional to the degree of similarity between two expression profiles. Shorter branches between genes indicates that the genes have more similar expression profiles. Generally, genes having similar functions will be clustered together, as shown by experiments done by Michael B. Eisen, et al. (1998).

Each row of the red/green plot represents a gene and each column represents an experiment. The color of the rectangle represents the expression level of that gene in that experiment, where down regulation is green and up regulation is red. Up/down regulation is relative to the reference state selected.

Genes can be selected by clicking on them in the red/green plot. Entire nodes of the tree can be selected by clicking on the desired node. All the genes selected are displayed in the selected gene list and highlighted across all views.

The method used to create the cluster tree is described by: Michael B. Eisen at al. (1998) Proc. Natl. Acad. Sci. USA 95, 14863-14868.

### Gene Profile

The gene profile displays a histogram of a single gene's expression levels over the series of experiments in the experiment group. Below the histogram is the gene description. One example of a gene profile is shown in FIG. 35.

### Creating Gene Profiles:

Highlight at least one gene in the gene list in the bottom window. Right-click on the highlighted gene(s) and choose “Show Profile(s)” (Ctrl+P), or click on the “Profile” button in the tool bar. The Profile(s) will open in the main analysis window.

### SRS and bioSCOUT

The SRS or similar interface allows the user to make text based queries of available in-house or other databases to find annotations about the genes that the user is interested in. The power of SRS lies in its unique ability to follow links between databases and essentially treat the different databases as one seamless repository.

The SRS software interface provides two modes of querying, simple and detail. The simple querying mode lets you submit a preconfigured query with the least amount of work on your part. The detail query mode, on the other hand, lets you configure your own queries to control the stringency and the complexity of your searches. Detail mode also allows you to perform linking operations.

The bioSCOUT function allows you to pull up complete feature reports summarizing the function and characteristics of the gene product.

### SRS Interface

The SRS interface is opened by clicking on the SRS button on the tool bar or choosing Analysis>Query SRS from the Analysis command menu. The interface opens within the software analysis window. Alternatively, other database search programs could be opened in a similar fashion.

### The SRS Interface Tool Bar

The tool bar has four option buttons: “Stop”, “Detail Mode” (“Simple Mode” when you are in the Detail Mode), “Submit” and “Deselect”. Table VlI illustrates these buttons and their actions.

[image]

### SRS Interface Windows

There are three windows in the SRS interface: the query window on the left, the results window on the top-right, and the entry window on the bottom-right.

### Query Window

The user constructs the queries in the query window. Preconfigured queries or databases (depending upon which query mode you are using) may be listed here and text fields for entering query terms will also be in this window.

### Results Window

The list of results found by your query will be in this window. Gene names, ID numbers and descriptions will be listed.

### Entry Window

The complete database entry for a selected result hit is displayed here.

### The SRS Interface in Simple Mode

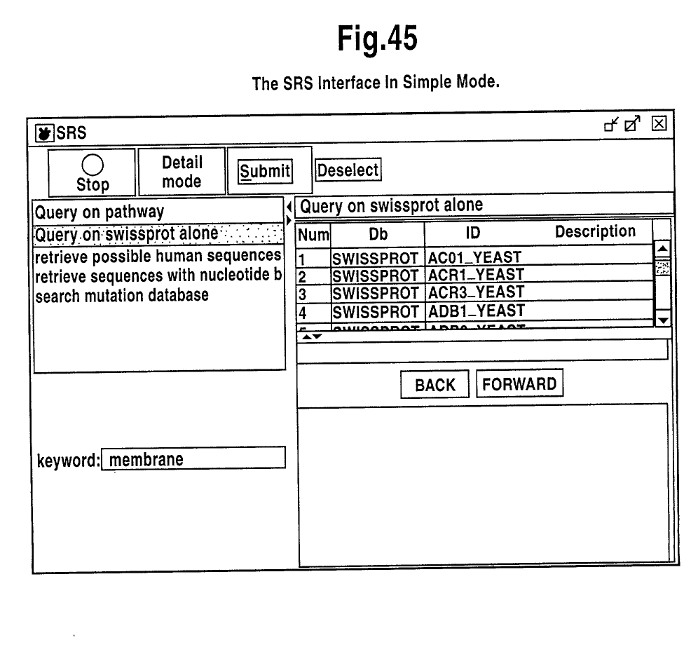

When in the simple querying mode, the query window will look different than when in the detail querying mode. The query window in simple mode displays a list of predefined queries. Below this list of queries, at the bottom of the query window, is a labeled text field. The label displays the database field, or type of database information, that will be searched in this query. The text field will display a predetermined query term appropriate for this query or will be blank. If it is blank, the user will enter their own query term or terms before submitting the query. A sample of the SRS interface in simple query mode is illustrated in FIG. 45

### The SRS Interface in Detail Mode

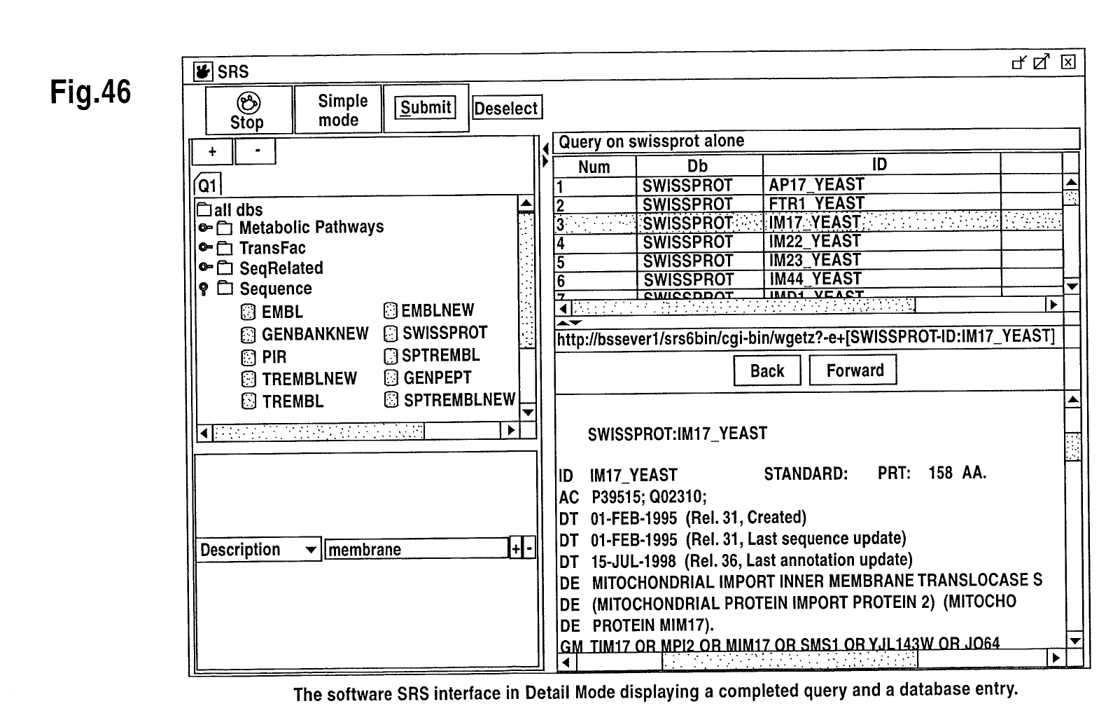

When in the detail query mode, the query window will have a tab listing the databases available to search. Below the tab will be a pull- down menu and a text field. The menu displays the list of available database fields for querying, e.g. Keywords and Metabolite. The contents of this menu depend upon the database(s) selected. If multiple databases are selected, only the fields available in all the selected databases will be available for querying. The text field is blank for typing in your query term or terms. Next to the text field are two buttons (+) and (−). The plus button opens an additional menu and text field for searching multiple database fields in one query. The minus button closes a text field and menu if you decide it is not needed. A sample SRS interface window in detail mode is illustrated in FIG. 46.

Above the Q1 tab in the window shown in FIG. 46 is a second set of plus (+) and minus (−) buttons, these are for linking. Clicking on the (+) button will open a new tab, Q2, for choosing a database or making a new query to link to the first query, Q1. Clicking on the (−) button will close the last tab opened.

### Querying in Simple Mode

Querying in simple mode is a user friendly way of making SRS queries for anyone without previous experience using SRS. In this mode, the user can choose from a list of preconfigured queries, e.g. “Query on pathway”, which will automatically run a set of database searches and linking operations to retrieve the specified information.

Once a simple query has been performed, the user can switch to the detail mode and the process used to carry out the query will be available to view. That is, each query and linking operation will be there as if the user had constructed the query in detail mode!

To perform a query in the simple mode, the user selects the query from the list and then, depending upon the particular query, either enters a query term in the provided text field or immediately clicks on the “Submit” button.

### Make a query in Simple Mode

Select a query in the left-hand window by clicking on it. Depending upon the query the user may or may not need to enter in a query term in the text field at the bottom of the query window. If there is no text in the text field already, enter a query term as discussed below.

The database field which will be searched with your query term is listed next to the query term text field. This information helps the user enter an appropriate term. Type your query term(s) in the text field. Multiple query terms entered in a single text field are typically separated with Boolean operators.

Click on the “Submit” button in the tool bar to launch the query.

### Querying in Detail Mode

In the detail mode the user can configure their queries to obtain the specific information needed from the databases selected by the user. The query can consist of a straight-forward search using a single query term to search a single database, or it can consist of a complex series of searches of multiple databases, multiple query terms combined with Boolean operators and linking operations.

The process of performing a query in the detail mode starts with selecting databases. Next, the user selects database fields to search, enters the query terms to search these fields and then submits the query. SRS then produces a list of results. The user can stop at this point or refine the query by adding additional searches. The user may also choose to receive information from a database that wasn't queried, based on the results of the fist query by linking the first query to another query or database.

### Make a query in Detail Mode

Select a database(s) by clicking or selecting a database in the Q1 tab. The Ctrl key (Cmd key on Mac) may be employed to select multiple databases. Select the database field to search from the pull-down menu in the query window. Enter a query term or terms in the text field next to the database field menu. Separate multiple terms with an operator. Click the “Submit” button.

### Selecting Databases

After entering the detail query mode, by clicking on the “Detail Mode” button in the SRS interface tool bar, a tab labeled Q1, in the query window, will list the databases available for querying.

Databases are grouped by type; to open or close a database group, click on the toggle switch for the group folder. To select a database, simply click on it in the list. Use the Ctrl key (Cmd on Mac) to select multiple databases. When selecting multiple databases, typically, the user may only be able to query fields that are present in all the selected databases.

### Entering Query Terms

After selecting the databases to search in the current query, a user may move to the bottom section of the query window. In some embodiments this section has a pull-down menu listing the database fields available for searching and a text field for entering a query term or query terms. Select the database field to search and type in an appropriate query term. Multiple query terms entered in a single text field can be combined with the Boolean operators “AND”, “OR”, “BUT NOT” by using the symbols shown in Table VIII.

TABLE VIII
Boolean Operators

| Symbol | Operator |
|---|---|
| & | AND |
| \| | OR |
| ! | BUT NOT |

A second database field menu and text field may be opened by clicking on the (+) button next to the first text field, and so on. When searching multiple fields in a single query, the field queries are combined with the “AND” operator by default. Hence, the results of such a query all meet the criteria specified for each of the database fields searched. If the user chooses the “OR” operator, the hits only have to meet one of the field criteria to be included in the results list. The “BUT NOT” operator returns a list of hits which meet the criteria of the first field search and do not meet the criteria defined in the second text field.

### Linking

### What is Linking?

A link is any reference in a database entry to another database entry in the same or another database. These links can be hyperlinks or text references. For example: EMBL database entry A's function was predicted by sequence similarity to Swissprot database entries B and C. In this case, a link exists between database entry A and B and between database entries A and C. It is very likely that there is a link between the entries B and C as well.

Linking is the process of following links to find entries in one database which are related to entries in another. Links can be followed directly, from entry A (from the above example) to entry B, or they can be followed indirectly, from entry A in Swissprot through entry B in EMBL to entry D in a third database.

### Performing a linking operation

Click on the (+) button above Q1. Select databases. Then select database fields to search or select “all entries” from the pull- down menu. Enter the query term(s) and then Click “Submit”.

To link the current query (Q1) to a second query or database, click on the (+) button above Q1. This will open a new tab, Q2. Select a database or databases by highlighting them as above. The user can either perform a new query to link Q1 to or link Q1 to the whole of the databases selected.

To link Q1 to a second query, perform the second query by simply proceeding as in Q1 to create Q2. Clicking on the “Submit” button will perform the linking operation, returning a result set containing the entries received by Q2 that are linked to the results of Q1. To link the results from Q1 to the entire database selected in Q2, select “all entries” from the database field pull-down menu, then click the “Submit” button. This linking operation will return a result set of entries from the databases selected in Q2 that are linked to the results of Q1.

### Results List

A list of genes matching your query, which are present in your current experiment group, will be listed in the results window. They are numbered one through n and the database they were retrieved from, ID and database descriptions are listed. This result set is automatically selected in all the open analysis views in the color of the SRS interface window frame and listed in the gene list window. Clicking on the “Deselect” button deselects these genes from the analysis views and removes them from the gene list window.

The first entry in the Results List is displayed in the Entry Window. If you want to see the entry for a different result, simply click on it in the result list. The desired database entry will now be displayed.

### Getting bioSCOUT Feature Reports

bioSCOUT is LION's sequence analysis package. With bioSCOUT the user can submit a sequence and a comprehensive feature report will be automatically generated. Alternatively, the software could be written to access/utilize other sequence analysis packages. To pull up the feature report for a selected gene, simply highlight the gene name in the gene list window and click on the “bioSCOUT” button in the tool bar. If the feature report has already been created, the HTML page will pop up in a new window. If the gene hasn't been previously analyzed in bioSCOUT, it will now be submitted to an automated bioSCOUT analysis (which could take some minutes to prepare depending upon your bioSCOUT server's processing capabilities and current load).

If the user does not have bioSCOUT in-house or another compatible analysis package, the user can easily have any HTML page, specific to the highlighted gene, open upon clicking the bioSCOUT button. The specification of which page opens upon clicking the “bioSCOUT” button is done by entering the link in the experiment class identifiers file.

### Administration

The administration functions include the import of locally stored data files, configuration of the software server and the removal of data from the database. Most of the administration functions should only be used by select individuals who have administrative access to the system. Whereas it is safe to allow all software users to upload RDB files, it is not advisable to allow many users access to the configuration files.

### Import

The import function allows a user to upload RDB files (tab delimited text), containing experimental data, from the local machine to the software server. The files are saved as flat files in a location designated by the software administrator Each set of raw data is uploaded individually and saved as an experiment. Experiments are named and categorized into classes, which identifies them as being related. Experiment names and classes may be used by all software users to identify the data, so a descriptive and consistent naming scheme is suggested.

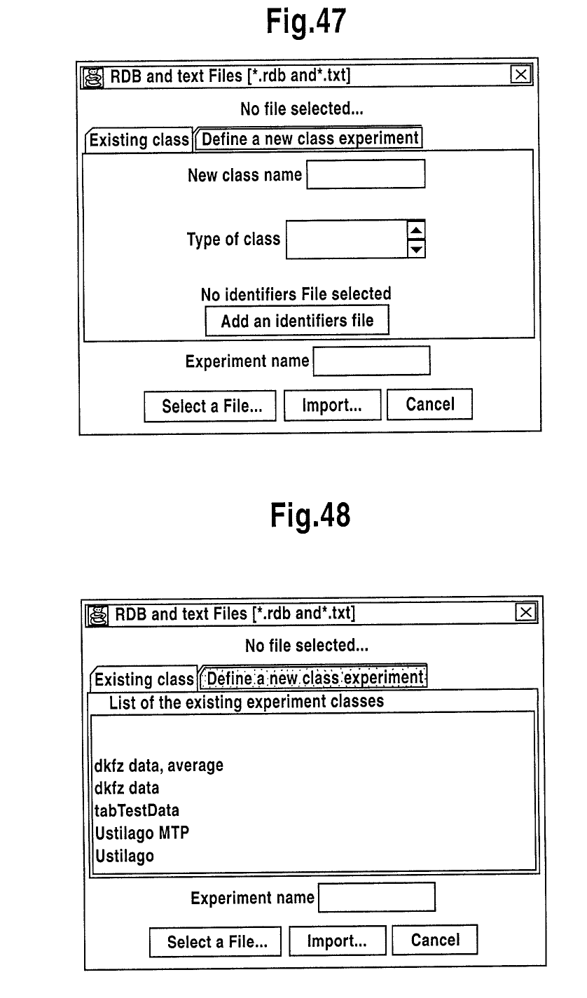

The dialog box for importing data has two tabs: “Existing class”, which lists all of the predefined classes and “Define a new experiment class”, which allows the user to create a new class. A sample of the “Existing Class” dialog box is illustrated in FIG. 47 and an example of the “Define a new experiment class” dialog box is shown in FIG. 48. Importing is done on both tabs, depending on if you are importing the data into an existing class or into a new one.

If a file is imported which has the same name as a previously imported file, the new file will be automatically renamed on the server to avoid overwriting the first file.

### Experiment Classes

Typically, a class should only contain data that can share an identifiers file. That is, all the experiments in a class should be done on the same set of genes. For organizational purposes, you can define many classes which use the same set of genes, and use the classes to group related experiments.

Classes are defined with an identifiers file which basically describes the genes on the chip, micro array, or membrane used to perform the experiments. It lists all the gene names, and (optionally) their SRS identifiers, a brief description of each gene in the set and a link to its bioSCOUT feature report or any HTML page. The name of the gene can be any name used at your site to identify the particular sequence. The SRS identifier is the accession number or sequence ID used by SRS to pull up the database entry which lists the annotation of the sequence. SRS may not function for genes who's SRS ID is not in the class identifiers file. The description is a brief remark about the gene which will be displayed in the gene list window and the gene profile window when that gene is selected/profiled. The link is the location of the HTML page which shows the complete bioSCOUT feature report. Alternatively, you could link the gene to any HTML page created by any sequence analysis system.

Minimally, one class should exist for each type of gene chip (etc.) used at your site. However, it is possible to define many classes for each gene set in use and these classes can all share an identifiers file. Typically, identifier files are be in RDB format and strictly comply with the defined format as outlined below: Some embodiments could utilize other file formats. There can be any number of comment rows at the top of the file, preceded by the hash symbol (#).

The first line of the file typically contains the column headers separated by tabs. The column headers are: “Name” (tab) “SRS” (tab) “Description”. The second line of the file may contain the column format strings separated by tabs. The format strings for the above columns are: “64S” (tab) “64S” (tab) “64S”, indicating that all columns are 64 characters in width and of type “string”.

Following, are all the genes and their information. Each piece of information, name, SRS ID, description, must be separated by a single tab as the column headings are—even though the data may not line up with the column headings. Such files can easily be created and edited using a spreadsheet program such as Starcalc or Excel. Table IX illustrates an example of a class identifier file.

TABLE IX
An example of a class identifier file.

#Perl-RDB # perl-rdb
#1999 September 13, Monday, 10:06 #

| | | |
|---|---|---|
| Name | SRS | DESCRIPTION |
| 64S | 64S | 64S |

| | | |
|---|---|---|
| YPR016C | SWISSPROT:IF6_YEAST | EUKARYOTIC TRANSLATION INITIATION FACTOR 6 (EIF-6). |

| | | |
|---|---|---|
| W95909 | EMBL:HSW9095 | ze43f10.s1 Soares retina N2b4HR Homo sapiens cDNA clone 361771 3′. |

| | | |
|---|---|---|
| AA045003 | EMBL:HSA45003 | zk63h01.s1 Soares pregnant uterus NbHPU Homo sapiens cDNA clone 487537 3′. |

| | | |
|---|---|---|
| AA044605 | SWISSPROT:PIN1_HUMAN | PEPTIDYL-PROLYL CIS-TRANS ISOMERASE NIMA-INTERACTING 1 (EC 5.2.1.8). |

| | | |
|---|---|---|
| W88572 | EMBL:HSW572 | zh70c10.s1 Soares fetal liver spleen 1NFLS S1 Homo sapiens cDNA clone 417426 3′. |

### Data Files

An importable data file contains a list of genes and the data for one experiment, i.e. one set of intensity measurements from one chip. At the very minimum it must contain the gene names and their intensities. It must also be in RDB format and comply with the defined format: Other embodiments may utilize other formats selected either by the user or the programmer. The description provided below illustrates RDB formatted files.

There can be any number of comment rows at the top of the file, preceded by the pound symbol (#). The first line of the file will contain the column headers separated by tabs. The column headers are: “Name” (tab) “Intensities” (tab) “Confidence”. The second line of the file contains the column format strings separated by tabs. The format strings for the above columns are: “30s” (tab) “10f” (tab) “10f”. Following, are all the genes and their information. Each piece of information, name, intensities, confidence values, must be separated by a single tab as the column headings are.

TABLE VIII
Example Data File

| # comments | |
|---|---|
| Name | Intensities |
| 30s | 10F |
| W95909 | 0.490000 |

| | |
|---|---|
| AA045003 | 0.820000 |
| AA044605 | 0.880000 |

| | |
|---|---|
| W88572 | 0.680000 |

| | |
|---|---|
| AA029909 | 0.850000 |
| AA059077 | 0.770000 |

### Table VIII illustrates an example data file. In this example, the columns and the column headers do not line up, but have the same number of tabs between them.

### Importing Data Into a New Class

From the menu bar, choose Administration>Import. The dialog box for importing will open. Click on the “Define a new class . . . ” tab. Type in a new class name, remember that this class should be descriptive for multiple experiments. Select the type of class: highlight a class in the menu that uses the same identifier file (uses the same chip) as your new class -or- click on the “Add an identifiers file” button to upload a new class defining file.

Click on the “Select a File . . . ” button. This will open a window for browsing through your computer's files to locate the desired data file. This window works just like any file browser. Find the desired file and double-click on it so that it is displayed in the “File name” text field. Click on the “Select” button to accept this file for import. In the import dialog box, type in an experiment name for this data file in the “Experiment name” text field under the class menu. If the experiment name is the same as the file name, you can leave this field blank. Click on the “Import” button to import the file as an experiment into the selected class, or click on “Cancel” to close the dialog box without importing the data into an existing class:

From the menu bar, choose Administration>Import RDB. The dialog box for importing will open. Click on the “Existing class” tab. Select a class by highlighting it in the menu. Click on the “Select a File . . . ” button. This will open a window for browsing through your computer's files to locate the desired data file. This window works just like any file browser. Find the desired file and double-click on it so that it is displayed in the “File name” text field. Click on the “Select” button to accept this file for import. In the import dialog box, type in an experiment name for this data file in the “Experiment name” text field under the class menu. If the experiment name is the same as the file name, you can leave this field blank. Click on the “Import” button to import the file as an experiment into the selected class, or click on “Cancel” to close the dialog box without importing the data.

### Change Configuration

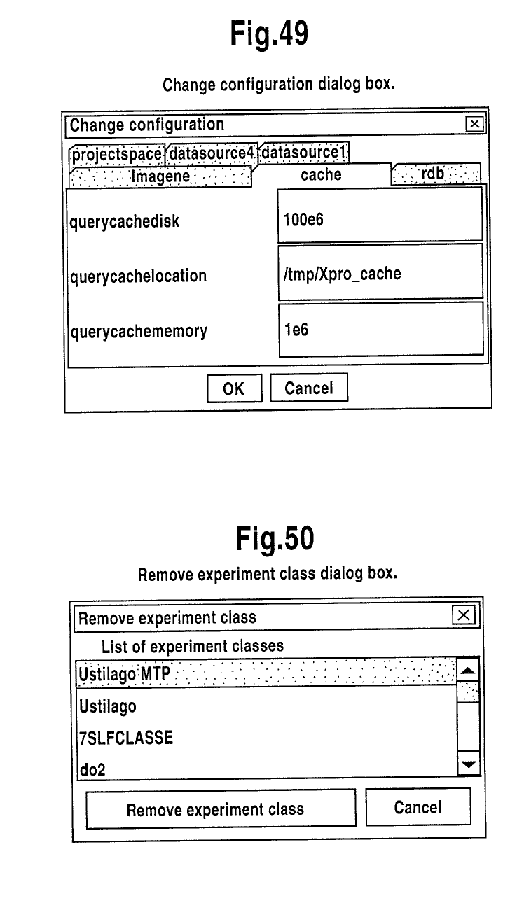

The change configuration function allows the user to read and write to the configuration file on the server to configure the software set up. There are several tabs in the change configuration dialog box: cache, rdb, project space, datasource1, etc.. The cache, rdb and project space tabs are standard, however the datasource tabs will differ slightly depending upon your system. A sample “Change configuration” dialog box is shown in FIG. 49. Each tab illustrated in FIG. 49 is discussed below.

### Cache

The “cache” tab lists the name of the cache disk, the location of the cache and the amount of memory allocated for the cache. You can change any of these by simply editing the value in the respective text field and clicking “OK”.

### RDB

The “rdb” tab lists the location where rdb data files, uploaded by all users, are automatically stored.

### Project Space

The project space tab contains the information about the space reserved for storage of projects and project list items. The login and database are shown and can be edited on this tab.

### Datasource1-n

The datasource tabs contain the information about the databases used by your software system. The information listed includes:

loginstring

The authentication string for logging into the database.

sqlset

Specification of the schema used for this particular database.

dbtype

The type of database, e.g. oracle.gatc.

datasourceid

Is unique, usually “datasource1”, “datasource2”, etc..

Typically, only a user with the proper authorization can change entries in these tabs. Changes are made by simply editing the value in the respective text field and clicking “OK”.

### Remove Experiment Classes/Experiments

The remove experiment classes and remove experiment functions allow an authorized user to erase experiment classes and experiments from the database. This will not only remove the files containing the data, but will also delete all dependent experiments and experiment groups from the project list.

### Remove Experiment Class

The remove experiment class dialog box has a menu which lists all the experiment classes. An example of this dialog box is illustrated in FIG. 50. To remove one from the database, simply highlight it in the menu and click the “Remove Experiment Class” button. You will receive a warning listing all of the experiment groups in the project list that are dependent on this class. These experiment groups will be deleted when you remove the experiment class.

### To Remove an Experiment Class

Select Administration>Remove Experiment Class from the command menu bar. Highlight the experiment class you wish to delete. Click on the “Remove Experiment Class” button. Confirm that the experiment groups can be deleted, click “OK”.

### Remove Experiment

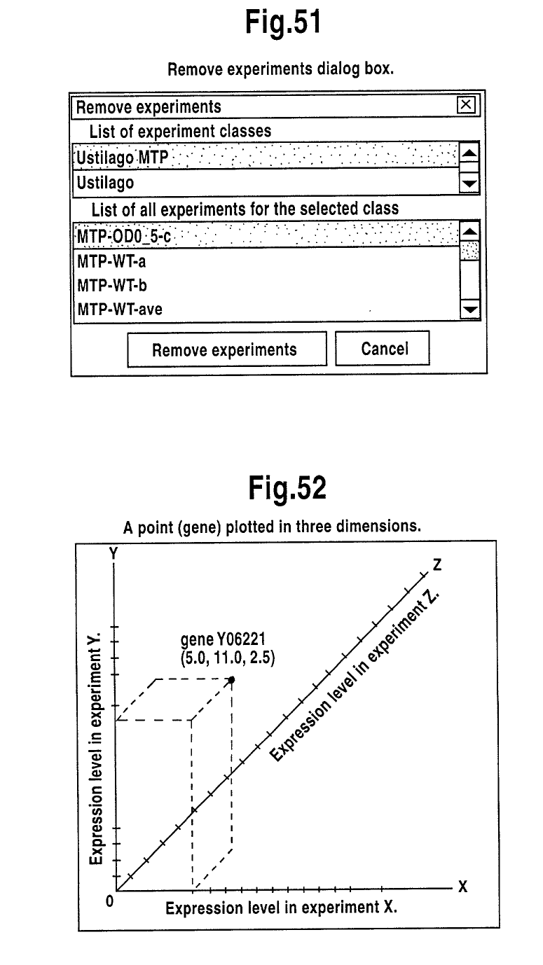

The remove experiment dialog box contains a menu for selecting an experiment class. A sample of this dialog box is shown in FIG. 51. Highlighting the experiment class will display all the included experiments in the lower menu. The user can select one or several experiments in the lower menu (use Ctrl or Cmd key to make multiple selections) and click on the “Remove experiment” button to delete only those experiments. A window will open listing all the experiment groups that will be affected. These experiment groups will be deleted from the project list when the experiments they are dependant on are removed from the database.

### To Remove an Experiment

Select Administration>Remove Experiments from the command menu bar. Highlight the experiment class containing the experiment(s) to delete in the top menu of the dialog box. Highlight the experiment(s) to delete in the lower menu.

Click on the “Remove Experiments” button. Confirm that the experiment groups can be deleted, click “OK”.

### Principle Component Analysis (PCA)

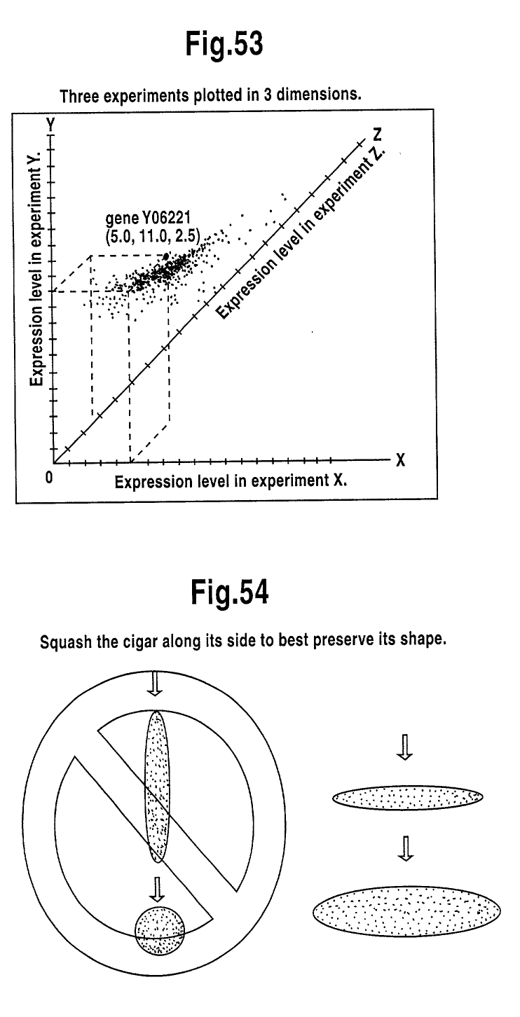

We can easily imagine plotting data from two experiments (like the difference plot) or three experiments in a two dimensional (2D) or a three dimensional (3D) scatter plot. However, it is much more difficult to imagine more than three experiments plotted in a scatter plot having as many dimensions. PCA is used to plot three or more experiments in a three or more dimensional plot and to display that plot in 2D or 3D. FIG. 53 provides an example of plotting three experiments in 3D. The results shown form a cloud of dots which have a defined shape (that of a cigar).

To display this in 2D, PCA finds the plane that optimally preserves the distances between all the points when they are displayed on the plane. This is some what similar to squashing a cigar in the direction which would best preserve its shape. This general concept is illustrated in FIG. 54.

In summary, numerous benefits have been described which result from employing the concepts of the invention. The foregoing description of an exemplary preferred embodiment to the invention has been presented for the purpose of illustration and description. It is not intended to be exhaustive or to limit the invention to the precise form disclosed. Obvious modifications or variations are possible in light of the above teachings. The embodiment was selected and described in order to best illustrate the principles of the invention and its principal application to hereby enable one of ordinary skill in the art to best utilize the invention in various embodiments and with various modifications as are suited to the particular use contemplated It is intended that the scope of the invention be defined by the claims appended hereto.

We claim:

1. An analysis method for large and/or complex biological data sets from molecular biology experiments, the method comprising:
a) importing data in a table data structure;
b) comparing data points;
c) calculating an optimized data representation; and
c) displaying the representation

2. Method according to claim 1 where for the analysis of large and/or complex biological data sets from arrayed biomolecules or derivatives/substitutes.

3. Method according to claim 2 whereby Step a) is modifying the original measurements to account for the experimental design and/or to emphasize aspects in the following analysis steps by using one of or combinations of methods listed below:
Shifting of values
Scaling of values
Exclusion of outlets
Merging of multiple measurements
Correction of neighbor influences
Selection of characteristics subsets.

4. Method according to claim 2 whereby Step b) is performed by eigenvalue calculation on a generalized similarity table for the data points and the derived eigenvectors of the similarity table define the optimized representation.

5. Method according to claim 2 whereby Step b) is performed on a generalized similarity table for the descriptive variables.

6. Method according to claim 2 whereby Step b) is performed by the analysis or a generalized similarity table for the descriptive variables to derive the representation of the data points.

7. Method according to claim 2 whereby Step b) can comprise one or more of the methods in claim 4 and where the similarity matrix used is chosen to be of smaller dimensions.

8. Method according to claim 7 whereby representation of the data points may be calculated from a similarity table for the descriptive variables by the following procedures:
a) Eighenvalues and eigenvectors are derived from the similarity table of descriptive variables; and
b) The eigenvectors and the representation of data points is subsequently constructed from the eigenvectors of descriptive variables as linear combinations of the original data with linear factors taken from the eigenvectors of the descriptive variables.

9. Method according to claim 2 whereby Step c) may consist of one of several of the following procedures:
a) graphical visualization of the optimized data representation;
b) graphical visualization of descriptive variables; and
c) graphical visualization of both, data points and descriptive variables in a common representation to highlight relationships.

10. Method according to claim 7 whereby graphical visualization of the optimized data representation is performed by placing data points at the co-ordinates obtained in the eigenvectors.

11. Method according to claim 8 whereby the optimal subset of eigenvectors is chosen for maximal explanation of the variance in the data as indicated by the biggest corresponding eigenvalues.

12. Method according to claim 7 whereby graphical visualization of the descriptive variables is performed by placing descriptive variables at the co-ordinates obtained in the eigenvectors.

13. Method according to claim 7 whereby graphical visualization for both, data points and descriptive variables in common representation is performed by placing descriptive variables and data points at the co-ordinates obtained in the corresponding eigenvectors and where the representation of variable may be scaled independently.

14. Method according to claim 7 whereby external biological or chemical or medical information is imported into the representation according to co-ordinates as calculated by a projection onto the eighenvectors and where their co-ordinates may be scaled independently.

15. Method for the analysis of large and/or complex biological data sets by extracting inherent structures of optimized explanatory power.

16. Method according to claim 1 whereby the analysis is performed on a computer.

17. An analysis method for large and/or complex biological data sets from molecular biology experiments, the method comprising:
a) importing data obtained from the experiments;
b) calculating a data representation using an algorithm; and
c) displaying the data representation in a display format wherein the metabolic path may be observed.

18. An analysis method for large and/or complex biological data sets from molecular biology experiments, the method comprising:
a) importing data obtained from the experiments;
b) calculating a data representation using an algorithm;
c) displaying the data representation;
d) selecting a data point of interest; and
e) displaying the selected data point so that the selected data point can be distinguished from non-selected data points.

19. The method of claim 18, wherein the selected data point represents a selected gene, the method further comprising:
f) displaying data points representing the selected gene so that the data points are displayed as selected data points.

20. An analysis method for large and/or complex biological data sets from molecular biology experiments, the method comprising:
a) importing data obtained from the experiments;
b) calculating a data representation using an algorithm;
c) displaying the data representation;
d) selecting a data point of interest; and
e) using a data base search to obtain additional information regarding the compound, gene, cell, virus, sequence, or substance represented by the selected data point.

21. A computer implemented method for analysis of large and/or complex biological data sets from molecular biology experiments, the method comprising:
a) importing data obtained from the experiments into a computer data storage system;
b) calculating a data representation of at least a portion of the imported data using a computer implemented algorithm; and
c) displaying the data representation on a computer display in a display format wherein the metabolic path may be observed.

22. A computer readable medium having computer readable program code for analysis of large and/or complex biological data sets from molecular biology experiments, the computer readable medium and a computer input/output system being capable of working together to carry out the steps of:
a) importing data obtained from the experiments into a computer data storage system;
b) calculating a data representation of the imported data using a computer implemented algorithm; and
c) displaying the data representation on a computer display in a display format wherein the metabolic path may be observed.

23. A computer implemented method for analysis of large and/or complex biological data sets from molecular biology experiments, the method comprising:
a) importing data obtained from the experiments into a computer data storage system;
b) calculating a data representation using a computer implemented algorithm;
c) displaying the data representation on a computer display;
d) selecting a data point of interest from the displayed data; and
e) displaying the selected data point so that the selected data point can be distinguished from non-selected data points on the computer display.

24. A computer readable medium having computer readable program code for analysis of large and/or complex biological data sets from molecular biology experiments, the computer readable medium and a computer input/output system being capable of working together to carry out the steps of:
a) importing data obtained from the experiments into a computer data storage system;
b) calculating a data representation using a computer implemented algorithm;
c) displaying the data representation on a computer display;
d) selecting a data point of interest from the displayed data; and
e) displaying the selected data point so that the selected data point can be distinguished from non-selected data points on the computer display.

25. A computer implemented method for analysis of large and/or complex biological data sets from molecular biology experiments, the method comprising:
a) importing data obtained from the experiments into a computer data storage system;
b) calculating a data representation using a computer implemented algorithm;
c) displaying the data representation on a computer display;
d) selecting a data point of interest from the displayed data; and
e) using a computer data base search engine to obtain additional information regarding the compound, gene, cell, virus, sequence, or substance represented by the selected data point.

26. A computer readable medium having computer readable program code for analysis of large and/or complex biological data sets from molecular biology experiments, the computer readable medium and a computer input/output system being capable of working together to carry out the steps of:
a) importing data obtained from the experiments into a computer data storage system;
b) calculating a data representation using a computer implemented algorithm;
c) displaying the data representation on a computer display;
d) selecting a data point of interest from the displayed data; and
e) using a computer data base search engine to obtain additional information regarding the compound, gene, cell, virus, sequence, or substance represented by the selected data point.
